(19) United States
(12) Patent Application Publication
(10) Pub. No.: US 2002/0031113 A1
(43) Pub. Date: Mar. 14, 2002

(54) Extended distribution of ADSL signals

(76) Inventors: David E. Dodds, Saskatoon (CA); Oliver Cruder, Saskatoon (CA); S. Mark Labbe, Saskatoon (CA); Ian Robert Meier, Saskatoon (CA); Michael David Lockerbie, Saskatoon (CA)

Correspondence Address: ADE & COMPANY, 1700-360 MAIN STREET, WINNIPEG, MB, R3C3Z3, CA

(21) Appl. No.: 09/902,444

(22) Filed: Jul. 11, 2001

Related U.S. Application Data
(63) Continuation-in-part of application No. 09/612,445, filed on Jul. 7, 2000.

(30) Foreign Application Priority Data
Jun. 7, 2001 (CA) 2,353,594

(51) Int. Cl. H04L 12/66

(52) U.S. Cl. 370/352; 370/503

(57) ABSTRACT

A plurality of metallic telephone lines carrying both baseband POTS (plain old telephone service) and DSL (digital subscriber line) or ADSL (asymmetric digital subscriber line) signals originate at customer premises and pass through a common field cabinet enroute to a telephone central office. Baseband POTS signals flow in an undisturbed manner through the field cabinet and maintain the normal, highly reliable, communication between the subscriber premises and the central office telephone switch. At the field cabinet, DSL/ADSL signals are removed from the metallic telephone line and are then communicated between the field cabinet and the central office using fiber optic broadband transmission. Fiber optic transmission increases the allowed distance between the ADSL transceiver located at the customer location and the respective ADSL transceiver located in the telephone central office. In one arrangement at the optical fiber, DSL and ADSL signals are retained in their 2B1Q, DMT, QAM or CAP analog format and are simply frequency translated in the process of frequency division multiplex (FDM) transmission. In another arrangement the analog data is converted by an analog front end of an ADSL modem into digital signals which are then made into a serial signal for transmission on the fiber optic cable The arrangements allow the provision of ADSL service to customers beyond the distance limit normally imposed by a completely metallic telephone line. It is understood that this arrangement is equally applicable to a variety of DSL (digital subscriber line) signals.

This application is a continuation in part of application Ser. No. 09/612,445 filed Jul. 7, 2000.

This invention relates to an apparatus for distributing ADSL signals to customer premises from a central office and to a remote module for use therein.

### BACKGROUND OF THE INVENTION

The use of the term ADSL herein is intended to include other forms of DSL signals which are available to one skilled in the art including HDSL, SDSL and VHDSL signals. Also the various forms of ADSL signals can be used such as DMT, QAM or CAP analog format.

The following U.S. patent references have been noted in a search:

U.S. Pat. No. 5,303,229 (Withers et al.) issued Apr. 12, 1994 entitled Optical Network Unit.

U.S. Pat. No. 5,408,260 (Arnon) issued Apr. 18, 1995 entitled Customer premises ADSL signal distribution arrangement.

U.S. Pat. No. 5,767,895 (Yashiro and Sasada) issued Jun. 16, 1998 entitled CATV Telephone System.

U.S. Pat. No. 4,891,694 (Way) issued Jan. 2, 1990 entitled Fiber optic cable television distribution system.

U.S. Pat. No. 5,917,624 (Wagner) issued Jun. 16, 1999 entitled Method and system for applying fiber to the curb architecture using a broadband gateway at service locations, including homes.

U.S. Pat. No. 5,940,738 (Rao) issued Aug. 17, 1999 entitled Video pedestal network.

With the widespread utilization of the Internet, it has been recognized that there is a demand for various forms of information to be communicated to and from customer premises such as residences. This information includes, in particular telephone service, security and metering services, Internet access and digital video-on-demand services. Internet access and specifically video-on-demand require very high data rates.

Optical fiber networks have the capability of meeting this demand, but do not generally extend to residential customer premises. Telephone subscriber lines extend to residential customer premises but have insufficient bandwidth to carry video signals until the recent development of digital video and DSL (digital subscriber line) technology.

Two technologies, namely cable TV modems, and ADSL (asymmetric digital subscriber line) systems, have been developed for delivering Internet services and bi-directional communications services to customer premises. Both technologies make use of existing wiring to the subscriber location and existing wiring within the customer premises and require, at most, minimal rewiring. Both technologies continue to support existing customer equipment and services.

ADSL typically provides a high data rate channel for transmission in a downstream direction from a telephone CO (central office) to a subscriber, a somewhat lower data rate channel for upstream transmission in addition to POTS (plain old telephone service), via a two-wire telephone subscriber line. Thus this technology can simultaneously communicate Internet data at as well as telephone signals bi-directionally, over a single telephone subscriber line which is referred to as an ADSL loop. ADSL technology, for example the type using multi-carrier modulation, makes it possible to send data at bit rates in excess of 6 Mb/s downstream on telephone subscriber lines.

The principles of multi-carrier modulation are described for example in “Multi-carrier Modulation For Data Transmission: An Idea Whose Time Has Come” by John A. C. Bingham, IEEE Communications Magazine, Vol. 28, No. 5, pages 5 -14, May 1990.

A significant problem in the widespread adoption of ADSL technology is the limited range of transmission. Practical limitations are 4 km from the CO for 1.5 Mb/s service and 2 km from the CO for 6 MB/s service. The telephone operating companies are unable to offer ADSL to many of their customers since the serving radius of each central office exchange is typically up to 5.5 km.

One solution to this problem is to shorten the ADSL loop by providing remote extensions to the telephone central office known as remote line units or RAM (remote access modules). Within these units, is provided a DSLAM (digital subscriber access multiplexer) that includes the ADSL modem that is normally located at the CO. The DSLAM digitally multiplexes the data from several ADSL loops and provides and interface to a high-speed digital channel connecting to the CO and typically implemented with SONET transmission on optical fiber.

Unfortunately, the RAM contains relatively bulky equipment that requires power and environmental control. The required enclosure is costly since it must be sized for future service growth and this cost is excessive when the RAM serves only a small number of ADSL customers. Furthermore, the extension of CO equipment into remote access modules requires the deployment of highly skilled service personnel who were previously required only in the CO.

With the movement of the CO side ADSL modems and the DSLAM into the field into a walk in cabinet (WIC) or a DLC cabinet, the ADSL is then terminated at the WIC, and brought back to the CO and then backbone via ATM. This technique has several drawbacks, the most costly being the cabinet itself.

The CO side equipment is not industrially rated, therefore the WIC must be heated and cooled. Because of the size of the WIC, and the heating and air conditioning, this method of extending ADSL reach is very expensive.

As well, it is often difficult for a telephone company to find a location for a WIC or obtain permission to install a WIC.

Furthermore, this equipment requires periodic maintenance, increasing the telephone company's truck-roll.

### SUMMARY OF THE INVENTION

It is an object of this invention, therefore, is to provide a more advantageous arrangement for distributing ADSL signals to and from customer premises and to extend the distribution area of ADSL signals.

It has been observed that telephone subscriber loop installations make use of passive field cabinets for the purpose of patch connections between distribution cables that connect to residential or business units and trunk cables that connect to the CO. A representative field cabinet provides patch connections for approximately 450 residential and business units.

The present invention provides a solution that eliminates the previously mentioned issues. The present invention operates by instead of terminating the ADSL system, repeating the analog ADSL signal and transmitting it over a pair of optical fibres: one for transmit and one for receive. Then at the CO end, the ADSL signal is terminated. The present invention, therefore, provides a transparent means of extending the reach of ADSL service. In addition to extending ADSL reach, it also improves the performance of ADSL. The data rates available over ADSL are highly dependant on the tip and ring line length. At short line lengths, bit rates of 8 Mbps are available, while at long lengths, the rate drops below 1 Mbps. Because field cabinets or SAC boxes are less than 2 km away from the customer's premise, the present invention effectively brings the CO within 2 km of the subscriber, bringing approximately 7 Mbps service to the customer. Rates at this level are high enough for streaming video, making the present invention an attractive solution for high performance web-based multimedia applications.

According to a first aspect of the invention therefore there is provided an apparatus for distributing ADSL signals to customer premises from a central office, comprising:

a central office;

the central office having a POTS switching system;

the central office having ADSL connection terminals that connect to a data network;

a plurality of customer locations at least some of which have at least one voice frequency POTS terminal and at least one ADSL terminal;

a field cabinet associated with the plurality of customers;

a plurality of individual metallic telephone lines each extending from a respective one of the customers to the field cabinet;

a trunk cable containing a large number of metallic telephone lines and extending from the field cabinet to the central office;

the field cabinet including a plurality of connections for connecting the individual telephone lines to the trunk cable for connection of signals between the customer locations and the central office;

the individual metallic telephone lines each being arranged to transmit both voice frequency POTS signals and ADSL signals between the respective customer location and the field cabinet;

a bi-directional link separate from the trunk cable for the transmission of ADSL signals between the field cabinet and the central office for connection to the data network; and

a splitter and interface module at the field cabinet having:

a plurality of signal splitting coupler units each associated with a respective one of the individual telephone lines and each arranged to separate the ADSL signals and the voice frequency POTS signals from the respective telephone line;

a plurality of connectors each arranged to connect the separated voice frequency POTS signals between the respective individual telephone line and the trunk cable; and

a plurality of interface units each associated with a respective one of the coupler units for receiving the separated ADSL signals from the coupler unit and for communicating the bi-directional ADSL signals on the bi-directional link between the central office and the respective individual telephone line.

Preferably the interface units at the field cabinet and the central office have a common receive and transmit clock and are synchronized in both directions providing precise loop timing where one end supplies the master clock for the channel and the clock is recovered at the other end, used to receive the data, cleaned up and used to send the data back.

Preferably the interface units at the field cabinets and the central office are arranged such that the framing information is continuously scrutinized at the receiving end to assure that channels are not scrambled in transit.

Preferably not all channels require the framing information to keep the system synchronized and wherein instead, each of the system's two field programmable gate arrays (FPGA) need only one framing channel.

Preferably only two of 32 channels contain the framing information.

Preferably once each ADSL symbol period (250 us), the least significant bit (LSB) of one channel's digital sample carries embedded framing information and in each symbol period, the digital value of this bit is overridden by the current value of a known pseudo random bit stream (PRBS).

Preferably the interface units are arranged to provide a maximal length sequence with a 15 bit period using a four bit linear feedback shift register (LFSR).

Preferably two independent sequences are used (one for each FPGA) and the same sequence is used for both upstream and downstream directions of a particular channel, where the sequences are defined by the following equations: X0 =X3 XNOR X4, and XO=X1 XNOR X4 and both sequences are seeded with all zeros.

Preferably the receiving end discriminates against invalid sequences by monitoring the a moving window of the four most recent bits of the bit stream and the discriminator tolerates no more than one bit error in the window and treats the case of two or more errors in the window as a framing error and therefore take corrective measures.

Preferably the interface units are arranged to use fixed gains (unity) for both downstream and upstream paths.

Preferably the interface units include Gigabit Ethernet (IEEE 802.3 compliant) laser transceiver modules, serializer-deserializers (SERDES), as well as ADSL coder-decoders (CODEC) and line drivers/receivers.

Preferably there is provided a plurality of interface units at the telephone central office each of which the bi-directional link associated with a respective individual telephone line and each of which provides an interface between the respective ADSL signals on the bi-directional link and the ADSL terminal of the central office.

Preferably each interface unit includes an analog front end unit for converting between analog signals transmitted to and received from the individual telephone line and digital signals for transmission on and receipt from the bi-directional link, Preferably the analog front end generates parallel data and wherein there is provided interface components for converting between the parallel data and a serial digital signal for communication on the bi-directional link.

Preferably the analog front end comprises an ADSL codec and filter.

Preferably the interface components include a serializer/de-serializer unit arranged to receive the parallel digitized ADSL signals and serialize them onto a single bit stream and to receive a serial bit stream and generates therefrom parallel data.

Preferably the serializer/de-serializer also is arranged such that if frame synchronization is lost, then the communication link is recreated by a protocol, whereby if a transceiver loses frame synchronization, it simply ceases transmission to the other transceiver, then the other transceiver will receive idle characters, signaling it to restart transmission and such that once the original transceiver detects frame synchronization, it will begin transmitting data again, and the link will be re-established.

Preferably there is provided a power supply unit arranged to receive power from each subscriber premises to power its own channel over the tip and ring phone line.

Preferably there is provided a power supply unit arranged to receive power from the central office to power the parts of the interface unit common to all channels.

Preferably the power supply unit is arranged to receive power from the central office by two tip and ring lines.

### BRIEF DESCRIPTION OF THE DRAWINGS

Two embodiments of the invention will now be described in conjunction with the accompanying drawings in which:

FIG. 1 is a schematic illustration of a distribution system for POTS and ADSL signals according to the present invention

FIG. 2 is a schematic illustration of the field cabinet of FIG. 1 including the splitter and interface module mounted therein

FIG. 3 is a schematic illustration of the additional components at the central office.

FIG. 4 is a block diagram showing the components of the digital embodiment of the field cabinet or SAC.

FIG. 5 is a block diagram showing the components of the digital embodiment of the Central Office.

FIG. 6 is a block diagram showing the components of the digital embodiment of FIGS. 4 and 5 for converting from the DSL signals to digital data in the downstream direction ultimately for transport on fiber.

FIG. 7 is a block diagram showing the components of the digital embodiment of FIGS. 4 and 5 for converting the digital data from the fiber to the DSL signals in the downstream direction.

FIG. 8 is a graph showing the values of signal to noise ratio over the dynamic range for the downstream direction.

FIG. 9 is a block diagram showing the components of the digital embodiment of FIGS. 4 and 5 for converting from the DSL signals to the digital data in the upstream direction ultimately for transport on fiber.

FIG. 10 is a block diagram showing the components of the digital embodiment of FIGS. 4 and 5 for converting the digital data from the fiber to the DSL signals in the upstream direction.

FIG. 11 is a graph showing the values of signal to noise ratio over the dynamic range for the upstream direction.

FIG. 12 is an eye diagram showing the eight possible trajectories of the received data for two bit time intervals.

FIG. 13 is a graph of the Gaussian distribution and a graphical meaning of its associated probability.

FIG. 14 is an eye diagram with superimposed PDF.

FIG. 15 is a Q-function plot.

FIG. 16 illustrates the components of a phase-locked loop.

FIG. 17 is an illustration of the components of the AFE at the field cabinet and CO ends.

FIG. 18 is an illustration showing the gain/attenuation of the components from the DSLAM to the customer.

FIG. 19 is an illustration showing the gain/attenuation of the components from the customer to the DSLAM.

FIG. 20 is an illustration of the components of the Outside Plant Equipment's programmable logic unit of FIG. 4.

FIG. 21 is a detailed illustration of the Outside Plant Equipment's master FPGA section of the programmable logic unit of FIG. 4.

FIG. 22 is a detailed illustration of the Outside Plant Equipment's slave FPGA section of the programmable logic unit of FIG. 4.

FIG. 23 is an illustration of the operation of the Outside Plant Equipment's programmable logic unit of FIG. 4.

FIG. 24 is a timing diagram for the AD16 and FPGA interface.

FIG. 25 is an illustration of the CO MUX programmable logic unit of FIG. 4.

FIG. 26 is an illustration of the CO MUX link state machine for the unit of FIG. 4.

FIG. 27 is a block diagram showing a third embodiment in which the Co is modified relative to the arrangement shown in FIGS. 4 and 5.

In the drawings like characters of reference indicate corresponding parts in the different figures.

### DETAILED DESCRIPTION

The arrangement of the present invention is a simple and cost effective solution for extending full-rate ADSL by distances of up to 10 km. The system extends ADSL distribution for as many as 32 subscribers by multiplexing/demultiplexing the copper wire signals over a single fiber optic cable pair. It can offset the need to deploy remote DSLAMs where subscriber take-rate is low. It can also augment distribution capacity where remote DSLAMs are full.

The arrangement of the present invention system consists of two sets of terminal equipment (outside-plant and central-office) separated by a fiber optic cable pair. Once installed, the components aid in deployment of long-range full-rate ADSL links between 32 subscribers and their associated DSLAM. Copper connections are still used between the subscriber and field cabinet and between the central office and the DSLAM. However, in this topology the ADSL signals are split from the POTS signals at the field cabinet and then are linked with the central office by means of fiber optics. At the central office the ADSL signals are restored to copper for connection to the DSLAM. Note that the ADSL splitter normally located near the DSLAM is no longer required.

The arrangement of the present invention consumes significantly less power per subscriber than does a remote DSLAM. It also allows deployment in much smaller increments than does a remote DSLAM. These features present new opportunities in ADSL distribution.

The traditional approach used to extend ADSL range and rate consists primarily of moving the DSLAM to the field and placing it in an environmentally controlled cabinet. The ADSL signals are then terminated in the field and then brought back to the CO and Internet backbone via ATM. Alternatively, hardened DSLAM's could be used in less environmentally robust cabinets. These techniques suffer drawbacks including the cost of the cabinetry, the real estate, and possibly the hardened DSLAM itself. Further, the bandwidth restrictions inherent in ATM may preclude the wide-span deployment of products such as digital interactive video (DIV). The arrangement of the present invention is a solution that eliminates the previously mentioned issues as the equipment can often fit inside existing cabinetry regardless of environmental grade. Its topology allows costly DSLAM's to remain at the central office where they can be closely monitored and maintained. Finally, as it is built on a full-rate non-blocking architecture, it will not impede the widespread deployment of high bandwidth technologies like DIV.

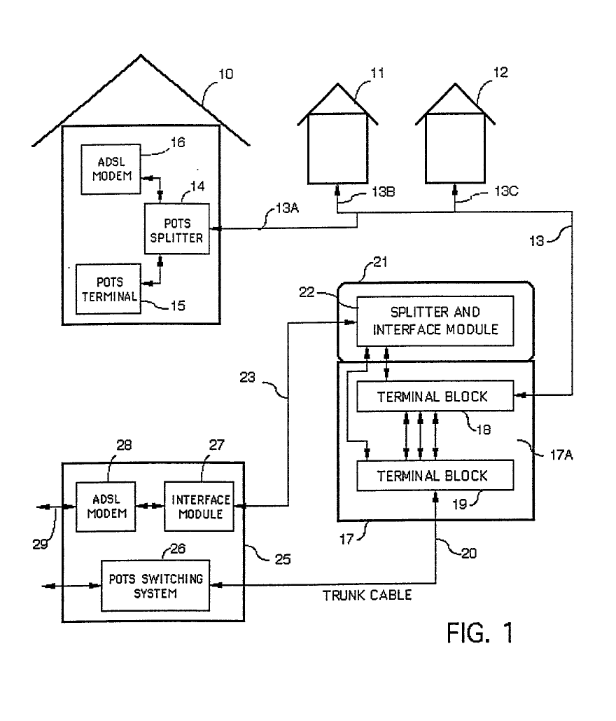

The arrangement of the present invention virtually brings the CO to within 2 km of each subscriber, allowing universal delivery of full-rate ADSL. Rates at this level are sufficient for streaming video, making The arrangement of the present invention an attractive solution for high performance web-based multimedia applications. FIG. 1 shows a high level view of one channel of the system.

The system is designed to require only minor installation effort. Once installed, it does not require any configuration or supervision to provide faithful service over extended periods of time. Periodic maintenance should include replacing the air filters of the outside plant equipment (OPE).

The system interfaces with 26 AWG copper tip and ring (T/R) pairs at both terminals. The two-wire T/R signal topology is respected whereby downstream and upstream signals coexist on each T/R pair. The following sections detail an analysis of the signal flow for both downstream and upstream cases.

The arrangements of the present invention include three possible embodiments described in detail hereinafter. The general scheme is shown in FIG. 1. In the first embodiment shown in FIGS. 1 to 3, the communication between the field cabinet or SAC and the central Office is effected using analogue communication of the data on a fiber optic or similar link. In the second embodiment shown in FIGS. 4 to 25, the communication between the field cabinet or SAC and the central Office is effected using digital communication based upon gigabit ethernet between a communication module at the cabinet and a similar communication module at the CO.

In the third embodiment shown in FIG. 27, the communication protocol and the communication module in the field cabinet are the same but the DSLAM and the communication module at the CO are replaced by an Optical Router, which is a commercially available unit from for example Cisco and is well known to one skilled in this art. This therefore directly feeds the system in the SAC box thus reducing the complexity of the system.

The general scheme is shown in FIG. 1 in which there is provided a plurality of customer locations indicated at 10, 11 and 12. Some of the customer locations will be of the arrangement shown at 10 wherein an individual metallic telephone line 13A within the distribution cable 13 of the telephone system to the customer location is fed into a splitter 14 which acts to separate the voice frequency POTS signals for supply to a POTS terminal 15 from the ADSL signals to an ADSL modem 16. Thus the customer's concern may have one or more conventional POTS terminals and one or more ADSL modems for communication along the common distribution cable 13. Some of the customer locations simply require the POTS connection and therefore do not include an ADSL modem or the splitter.

The distribution system further includes a field cabinet 17 which conventionally comprises a first portion 17A which simply is a passive construction including terminal connectors 18 an 19 by which the distribution cables 13 are connected to a terminal block 18 and a trunk cable 20 is connected to a second terminal block 19 with jumpers connected to the two terminal blocks to provide the required connections from a trunk cable to the individual subscriber locations.

In the present invention the field cabinet is supplemented by an additional housing 21 which contains a splitter and interface module 22. This module is provided for the use of the ADSL customers and is used to separate the signals of those ADSL customers into the separate module from which the POTS signals are separated from the ADSL signals for communication of the POTS signals along the conventional trunk cable 20 while ADSL signals are transmitted through an additional bi-directional link 23. Both the bi-directional link 23 and the trunk cable 20 communicate with the central office 25 as separate communication links so that the POTS signals on the trunk cable 20 are communicated to a POTS switching system 26 and the ADSL signals on the link 23 are communicated through an interface module 27 to an ADSL modem 28 connecting to a network 29.

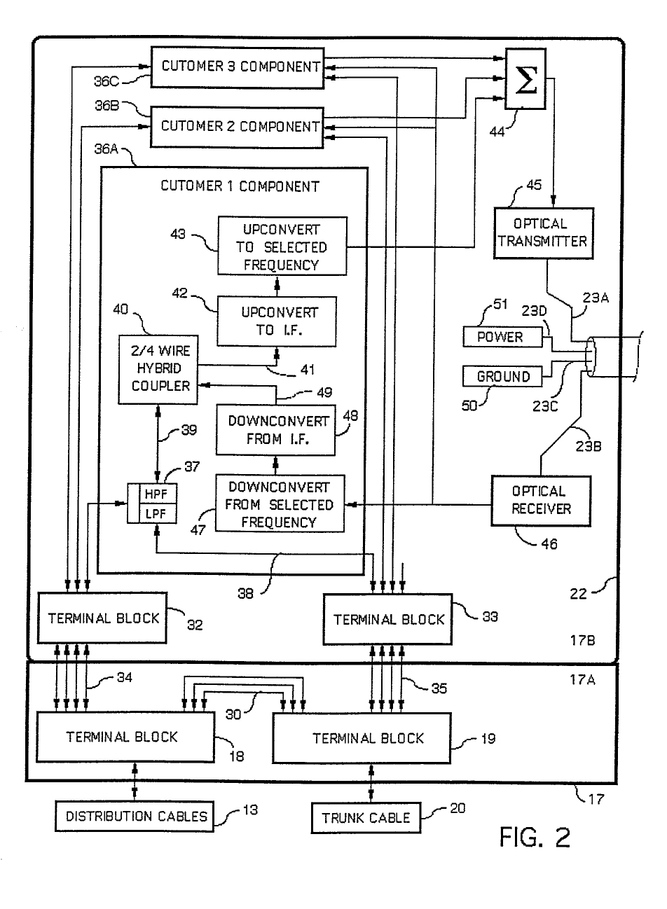

Turning now to FIG. 2, the field cabinet 17 is shown in more detail and includes the terminal blocks 18 and 19 within the conventional housing section 17A with some connections 30 extending directly between the blocks 18 and 19 for customers who do not require ADSL services.

On top of or at one side of the conventional field cabinet 17 is provided an additional housing 17B. This contains the module 22, the structure of which is shown in FIG. 2 and includes two terminal blocks 32 and 33 by which jumpers 34 and 35 can be connected to the blocks 18 and 19 respectively. Thus the signals containing both the POTS and ADSL signals to and from the distribution cables 13 for the ADSL customers are connected to the terminal block 32 separately for each of the individual customers along a separate jumper connection 34.

For each customer, the module contains a separate splitter and interface module component 36A, 36B, 36C et seq. Each of the components 36A, 36B, 36C contains for each customer the same functions so that only one of the interface components 36A is shown in detail. This includes a high pass/low pass filter 37 which is arranged to separate the POTS signals from the ADSL signals. Examples of splitters of this type are shown in U.S. Pat. Nos. 5,528,630 and 5,627,501 and are well known to one skilled in the art. The details of the above patents are therefore incorporated herein by reference as examples of splitters which can be used for the splitter arrangement 37.

The POTS signals from the low pass filter component are communicated through a connection 38 to the terminal block 33 and then are supplied through a respective of one jumpers 35 to the respective location on the terminal block 19 thus reconnecting the POTS signals in the same connection that they would normally take from the respective distribution cable 13 to the respective location on the trunk cable 20.

The ADSL signals from the splitter 37 are supplied through a connector 39 to a hybrid coupler 40. Again the coupler 40 which acts as two/four wire coupler is of a conventional nature widely used in this industry and acts to separate the signals on the two wire connection 39 into a four wire connection provided by a first connection 41 and a second connection 49 for upstream and downstream signals respectively.

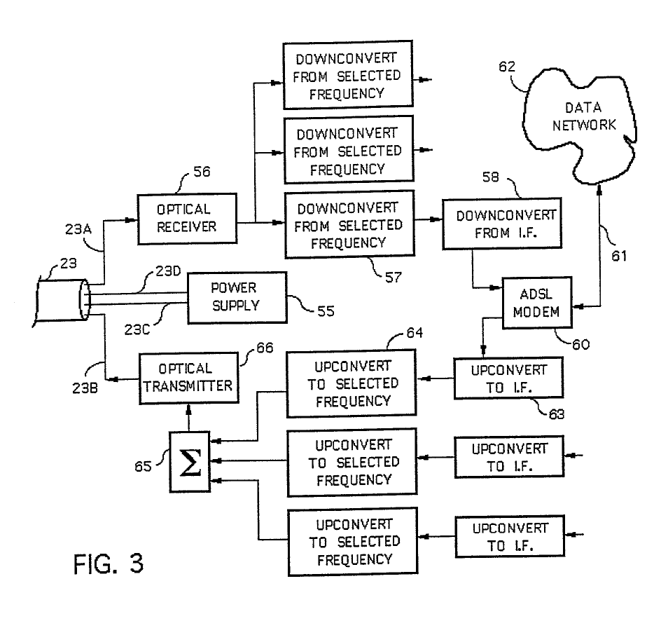

In the first embodiment shown primarily in FIGS. 2 and 3, the signals from the customer location are communicated on the line 41 to a frequency translator for communication on the link 23. In the embodiment shown the frequency translator comprises a first component 42 and a second component 43 which combine to translate the ADSL signals into a respective one of the plurality of video channel frequency bands which are available on the link 23. Thus each customer is allocated a specific one of the interface components 36A so that the signals from that customer are communicated only to that component and the customer is also allocated a specific frequency band within the available frequency spectrum. For convenience the frequency bands are selected to be the same as conventional CATV bands which provides a bandwidth of 6 MHz. ADSL signals use a portion of this bandwidth in the range 20 kHz to 1.1 MHz. However the bandwidth may be greater or smaller depending upon requirements and in some case for example in Europe the CATV bandwidth is conventionally 7 to 8 MHz and yet in other cases the band width may be significantly greater to provide enhanced signal communication capability and up to 20 MHz may be required in such circumstances.

In order to make use of commercially available equipment, the frequency translation is effected into two steps using the separate components 42 and 43. Thus the first component 42 converts the signals by a double side band transmitted carrier modulation of a radio frequency carrier at an intermediate frequency which selected to be 45.75 MHz. Thus preferably the signal translation is effected by AM-DSB-TC modulation of the radio frequency carrier. This modulation technique is again well known to one skilled in the art and suitable components are available commercially.

The second component 43 is a conventional commercially available CATV modulator which translates from the intermediate frequency up to the selected band for that particular customer. Such devices are well known to one skilled in the art and are readily commercially available for use in commercial equipment for CATV communications.

The frequency translated ADSL signals from the individual customer components are communicated to a summing point 44 again of a conventional nature. These signals are then transmitted on the link 23.

In the embodiment shown, the link is a fiber optic cable including two unidirectional cable elements so that the signals from the summing point 44 are transmitted to an optical transmitter 45 for transmission along the cable portion 23A to the central station.

In a directly symmetrical manner, the cable portion 23B communicates signals optically from the central station to the module 22 and particularly to an optical receiver 46 of the module. The optical signals are transmitted to the components of the individual customers where the signals from the particular band allocated to that customer are frequency translated back down from the band to provide the ADSL signals for supply to the line 49 to the coupler 40. Thus again the translation is effected in two separate components indicated at 47 and 48 which operate symmetrically to the components 42 and 43 as previously described. The signals from the coupler 40 thus are bi-directionally communicated through the connector 39 and back through the splitter 37 to the customer location through the respective distribution cable 13.

The use of the bi-directional link allows the ADSL signals separated from the POTS signals to be transmitted without appreciable limitation on distance of transmission through the link which is dedicated to the connection between the central station and the particular field cabinet with which the customer's identified are associated.

The module 22 receives power through the fiber optic cable of the link 23 via metallic conductors 23C and 23D which connect to the ground line 50 and to a power line 51 respectively. The ground and power are thus provided to the module and to each of the individual components associated with the respective customers.

Turning now to FIG. 3, at the central station is provided a symmetrical arrangement to the module 22 at the field cabinet. Thus there is provided a power supply 55 for communication of the power and ground to the field cabinet over the metallic conductors 23C and 23D of the link 23. The signals on the unidirectional link 23A are received by an optical receiver 56 and are supplied to a plurality of down converter components 57 each associated with a respective one of the frequency bands and each arranged to converter the frequencies from that band to provide the ADSL signals associated with the respective customer. Again the down conversion is effected in two steps by components 57 and 58 symmetrical to the components 42 and 43 previously described. The ADSL signals of the respective customer are therefore communicated to a respective ADSL modem 60 and through that modem to the data network 62. Similarly return signals from the data network 62 are received by the ADSL modem and communicated through frequency translation components 63 and 64 to the optical transmitter 66.

Thus each of the components set forth above in the module at the field cabinet and in the module at the central station are commercially available components connected and configured to provide the advantages set forth above.

In an arrangement in which the optical fiber connection is replaced by a conventional co-axial cable, a single co-axial cable can be used for communications in both directions and in this case each customer will be allocated a first frequency band for communications in one direction and a second frequency band for communications in the opposite direction.

An advantage of the invention is that no specific signal format is required for transmission of DSL signals and that future DSL signal formats can be accommodated by the proposed structure.

A further advantage of the invention is that a variety of DSL signals can be accommodated at a specific field cabinet. Furthermore, equipment at the CO for a specific type of DSL transmission can service a number of customers that are associated with a diverse variety of field cabinets.

It is required that the signal coupler unit within the field cabinet splitter and interface module does not interrupt “lifeline” POTS service in the event of power failure or equipment failure.

Although it goes against present practice for ADSL installation, it is also possible to tap into the telephone line at the filed cabinet without breaking the existing patch wire. The metallic telephone line would thus not be routed through the signal splitting coupler (or filter) in the splitter/interface module.

Turning now to FIGS. 4 to 25, there is shown an arrangement which effects the data transmission on the fiber optic cable using digital signals.

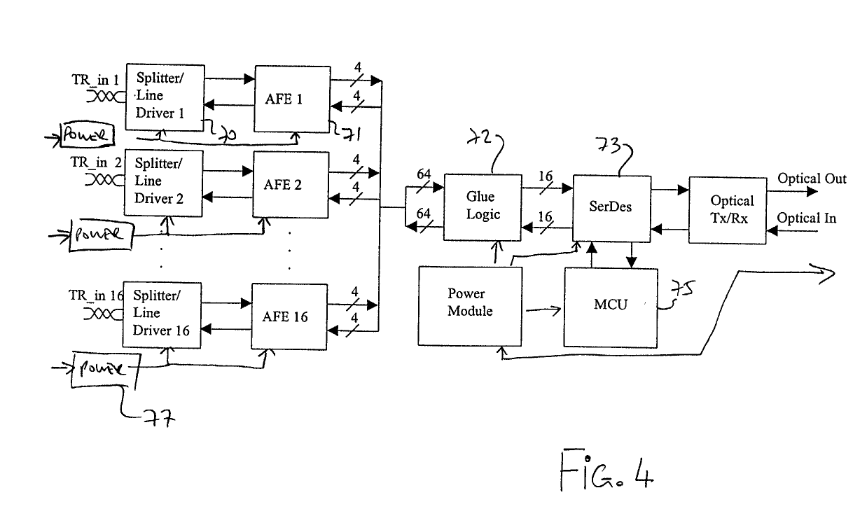

The hardware is shown in FIGS. 4 and 5 which are described generally in the following brief overview of the operation. Only one direction will be described as the system is basically symmetrical and thus the system operates the same way for both directions.

The samples from each AFE from the respective channel of the respective subscriber are formatted for transmit by a programmable logic unit 72 of a common channel. The output of the programmable logic unit 72 is serialized by a serializer/de-serializer unit 73. This high-speed serial data is then converted into an optical signal by the optical transceiver 74, and is transmitted over the optical fibre to the central office. At the CO end, the optical signal is converted to an electrical signal by the optical transceiver. The unit 73 then de-serializes the serial digital signal into parallel words. The programmable logic then takes the parallel data, separates each individual channel, and provides this data to each of the AFEs 71 of the respective channels, which convert the digital signal into analog. These ADSL signals then are sent to the CO, where they are terminated by the CO side ADSL modems and the DSLAM.

The system is controlled by programmable logic 75 which is used to manage the communication protocol as well as provide for diagnostic features. A power module 76 provides power to the common components of the system, either from an external source, or more preferably as shown, from two or more tip and ring circuits from the CO. Power to the individual channels of the respective subscribers is provided by a power unit 77 receiving power from the tip and ring circuit of the respective subscriber line.

The two-to-four wire unit 70 is used to separate transmit and receive signals on the tip and ring line to the subscriber and to the central office. A hybrid is not required because the ADSL transmit and receive signals occupy different frequency bands; however, it is used to reduce near end echo at the receiver. The line driver is required to transmit the ADSL signal on the tip and ring phone line at the required levels. The inputs to the two-to-four wire unit are the analog ADSL signals to be transmitted, and the full duplex signal that needs to be separated into transmit and receive signals. The outputs are the separated ADSL signal that will be digitized, and the full duplex signal to be transmitted.

The inputs to the AFE at the SAC end are the analog ADSL signal from the subscriber, and the digital signal from the programmable logic unit 72. At the CO end, the inputs are the ADSL signal from the CO, and the digital signal from the programmable logic unit 72. The outputs at the SAC end are the analog ADSL signal that is sent to the subscriber, and the digitized ADSL signal that is sent to the programmable logic. The outputs at the CO end are the analog ADSL signal that is sent to the subscriber, and the digitized ADSL signal that is sent to the programmable logic unit 72.

The programmable logic unit 72 is required to interface between the serializer/de-serializer unit 73 and the AFE. The digital interfaces of the SAC and CO AFE circuits are very different. The SAC AFE has a 16 bit parallel interface, while the CO AFE has a serial interface. The programmable logic must provide an appropriate interface between each of the AFE circuits and the serializer-deserializer. This programmable logic is either accomplished with digital components or an FPGA. As well as the multiplexing-demultiplexing functionality, the programmable logic must also establish AFE's word synchronization. The communication protocol may also be managed in the programmable logic, or else in a microcontroller. The inputs to the programmable logic block are the data from the AFEs and the data from the serializer/de-serializer unit 73. The outputs are the data to be sent to the serializer/de-serializer unit 73 and the data to be sent to the AFE.

The serializer/de-serializer unit 73 is an important component of the system. The serializer/de-serializer unit 73 takes the channels of digitized ADSL signals, and serializes them onto a single bit stream. It also takes a serial bit stream and generates 8 bit wide parallel data. The serial data rate is approximately 1.25 Gbits/s, so the interface between the serializer/de-serializer unit 73 and the optical transceiver must be carefully designed, due to the high data rate. The transceiver establishes frame synchronization once at the beginning of transmission, and not at a regular interval. If frame synchronization is lost, then the communication link must be recreated. This is accomplished by a very simple protocol, whereby if a transceiver loses frame synchronization, it simply ceases transmission to the other transceiver. Then the other transceiver will receive idle characters, signaling it to restart transmission. Once the original transceiver detects frame synchronization, it will begin transmitting data again, and the link will be re-established. The inputs to the serializer/de-serializer unit 73 are the data from the programmable logic, and the serial data stream from the optical transceiver. The outputs of the serializer/de-serializer unit 73 are the data to be sent to the programmable logic, and the serial data stream to be sent to the optical transceiver.

The optical transceiver is used to convert the serial data from the serializer/de-serializer unit 73 into an optical signal and the received optical signal into an electrical signal to be received by the serializer/de-serializer unit 73. The inputs to the optical transceiver are the electrical serial data from the serializer/de-serializer unit 73 and the received optical signal. The outputs of the optical transceiver are the electrical serial data to be sent to the serializer/de-serializer unit 73 and the optical signal to be sent to the remote end of the system.

The power module is used to provide power to the system. The goal is to allow power to be supplied by an external source, or by the subscriber and CO. Considering the lafter approach, each subscriber premises powers its own channel over the tip and ring phone line, and the CO powers the equipment common to all channels, such as the serializer/de-serializer unit 73, the programmable logic, the optical transceiver, and the microcontroller. Powering of the common equipment can be accomplished by two or more tip and ring lines.

The microcontroller or programmable logic is used to allow for system diagnostics, and possibly to manage the communications protocol between the two serializer/de-serializer units 73. Also, some parts in the system need general supervision, so it will function to manage the entire system.

A detailed description of the components and operation based upon the above general description will now follow.

Downstream Signal Analysis

Bandwidth

G.dmt: 180 kHz to 1104 kHz

For full-rate ADSL, the downstream signal uses DMT tones 45-255 (FDM).

PSD Mask

The system must be in compliance with the PSD mask described in ANSI T1 -413, section 6.14. The ANSI standard describes the transmitter PSD for both FDM and echo cancellation modes. The System employs FDM technique, which separates downstream from upstream band. The downstream transmit PSD within 180 kHz to 1104 kHz passband is no greater than −36.5 dBm/Hz. The passband ripple during steady-state is no greater than +3.5 dB; the maximum PSD of (−40+3.5 ) dBm/Hz applies across the whole passband from 180 kHz to 1104 kHz. In the band from 0 to 4 kHz (POTS), the PSD is no greater than −97.5 dBm/Hz.

The system itself simply codes and subsequently reconstructs signals generated by ADSL modems. It is designed to not provide any gain across the spectrum. Thus if ANSI T1 -413 compliant modems are used, the system will not violate the standard.

Signal to Noise Ratio

The maximum signal subject to The system's CO AFE input is as described herein. Noise is injected in the ADSL signal along the processing chain. A variety of hardware has been adopted to perform the various functions. The following is an analysis of the resulting signal to noise ratio (SNR). The analysis will show that ultimately the SNR is approximately 75 dB.

DSL to Fiber

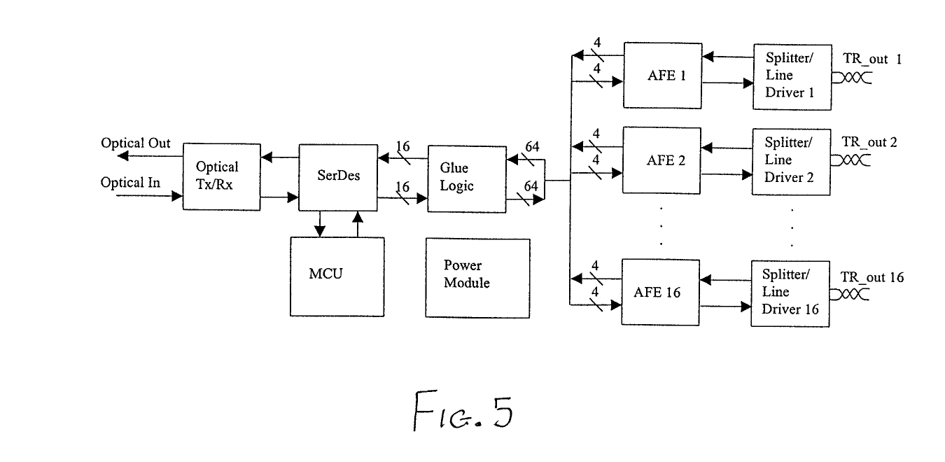

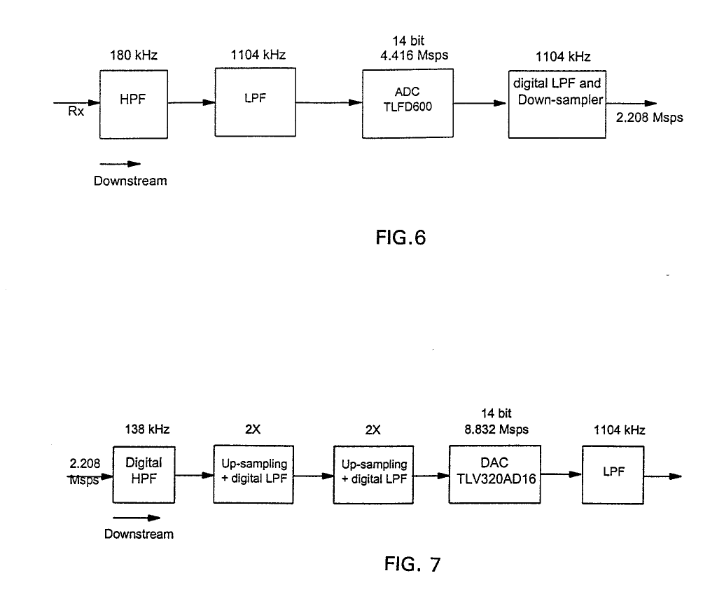

This part of the system shown in FIG. 6 includes a CPE CODEC with its components: high and low pass filters, analog-to-digital converter (ADC), and decimation filter.

Analog Filtering

The high pass analog filter is used to reject the near end echo and maximize the dynamic range of the ADC. The corner frequency of the filter is 180 kHz. The low pass analog filter is also used to reject the out-of-band signal. The corner frequency is 1104 kHz. These two analog filters are used to reduce aliasing in the ADC.

Quantization

The ADC's sample rate is 4.416 MHz providing 2 × over-sampling. The SNR of an ideal A/D converter given a full scale signal can be calculated using the following equation:

$$SNR [ dB ] = 10 log \frac{3 \cdot {2}^{2 N}}{{K}^{2}}$$

N—number of bits of ADC

K—crest factor (peak-to-average ratio of the signal); K=5 for ADSL signal

The noise introduced by ADC is called quantization noise. With a 14 -bit ADC the SNR of ADSL signal is computed ad 75 dB.

Digital Filtering and Down-Sampling (Decimation)

Quantization noise power can be reduced by virtue of the 2 ×over-sampling technique. The signal is sampled at 4.416 Msps, 2 ×the Nyquist rate. The quantization noise is white, so its power spectral density is constant over the frequency range [−2.208 MHz, 2.208 MHz]. Since the signal bandwidth is 1.104 MHz, we can pass the output signal from ADC through the digital low pass filter with cutoff frequency 1.104 MHz to reduce the quantization noise by 3 dB. In practice the gain due is less than 3 dB since the decimation filter is not ideal and so does not completely eliminate the noise in the stop band

Since the spectrum above 1.104 MHz has been suppressed, the samples can be decimated by a factor of two by discarding every second sample. The new sample rate is 2.208 Msps and the noise reduction remains at approximately 3 dB. Thus the total SNR in A/D conversion is now 78 dB.

Spectral Aliasing

Because the digital filter is not perfectly sharp, it does not completely eliminate the noise in the stop band before the signal is down-sampled. For this reason a certain amount of spectrum energy (signal and quantization noise) is translated from the stop band back to the signal bandwidth. Therefore, aliasing noise inevitably contributes to processing noise in the upper signal bandwidth (between 900 kHz and 1.104 MHz).

The aliased quantization noise is at the noise floor of the 16 bit digital signal processor and so adds very little to the total noise power. Conversely, the aliased signal noise could have a much more significant effect. This depends on the signal power above 1.104 MHz. Although signals above 1.104 MHz are not useful (they are in fact destructive to the SNR), the PSD mask shows that they are permitted and would deteriorate the SNR.

Numerical Truncation

All processing past the quantization stage is performed using 16 bit digital signal processing (DSP); however, samples are ultimately truncated to only the most significant 14 bits for efficient transmission on the optical fiber.

The truncation process seemingly eliminates the advantage of the 16 bit DSP; however, use of a 16 bit DSP allows the noise sources to be less significant than if 14 DSP were preformed. The effective SNR remains near 75 dB despite the various noise sources.

Fiber to DSL

This part of the system shown in FIG. 7 includes OPE CODEC with its components: digital high pass filter, up-sampler with digital low pass filter, digital-to-analog converter (DAC), and analog low-pass filter.

Up-Sampling and Digital Filtering (Interpolation)

The digital downstream signal that comes from the fiber arrives at 2.208 Msps. It is then up-sampled to accommodate the DAC operating at 8.832 Msps. The over-sampling does not cause aliasing, but it raises the Nyquist frequency to include additional spectral copies of the signal. The copies are eliminated by a digital LPF following each up-sampler leaving only the base-band signal. The chain shown in FIG. 7 contains two up-sampling stages with digital LPFs for a 4 ×over-sampling rate.

The analog signal output from 14 bit DAC passes through 1.104 MHz analog reconstruction LPF in order to remove spectral copies produced by the DAC at the harmonics of the sampling rate. Over-sampling relaxes the requirement for high order reconstruction filters and reduces DAC noise.

Numerical Truncation

Regardless how much the digital filters attenuate the noise, the DAC's resolution limits the lowest possible noise level. In the case of a 14 bit DAC, the SNR is computed as 75 dB for ADSL signals. Other noise sources may have been overlooked leading to an actual SNR somewhat lower than that presented here.

Dynamic Range

The DSLAM's analog signal is attenuated by 21.8 dB so as not to saturate the ADC of the AFE. The attenuation assures that a full power DSLAM signal results in full-scale (3 Vpp) at the ADC.

We fix the AFE's input gain/attenuation regardless of input signal level received. At full DSLAM output power, the SNR is as discussed in the previous section. When DSLAM output power is attenuated by copper losses or by modem power level negotiations, the SNR is reduced by nearly the amount of the signal reduction (the slight benefit is due to the associated reduction in aliasing noise).

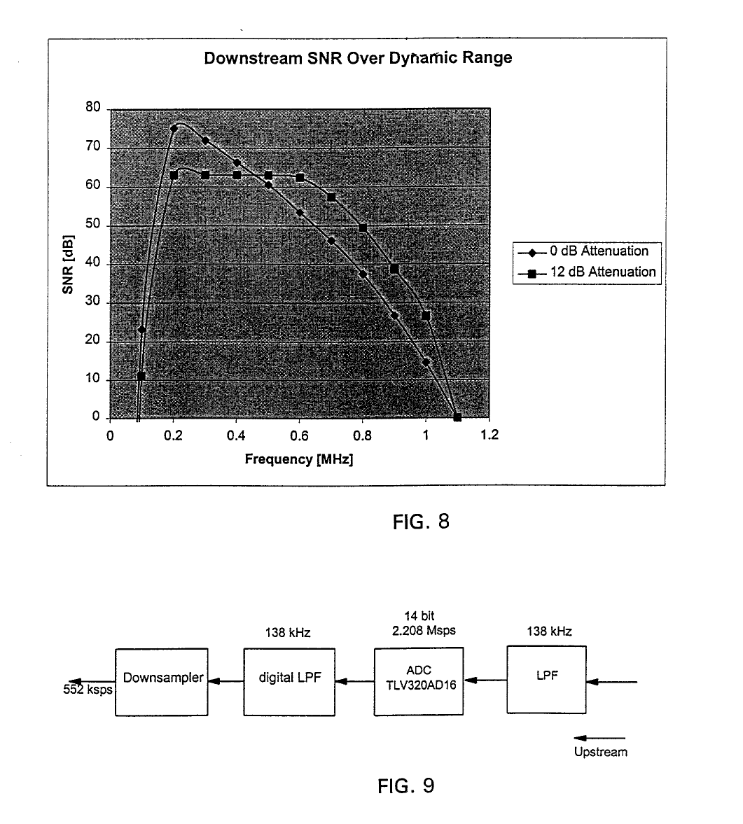

FIG. 8 shows the over-all downstream SNR over frequency across the dynamic range of the input signal. Ideally the SNR would be flat across the band; but we notice that the SNR decreases as frequency increases. The degradation is due primarily to aliasing of signals above 1.104 MHz in the down-sampling process. Note that the worst possible case for out-of-band signal power has been assumed in the analysis (PSD mask described in herein).

The maximum reduction of a DSLAM's output power due to modem negotiation is 12 dB. Since The system's CO AFE is designed for direct connection to the DSLAM, there is no significant additional signal loss in the copper. In this case, the input signal is 12 dB smaller than that of full-scale at the ADC. This results in a SNR reduction of approximately 12 dB or a total SNR (the worst case) of 63 dB.

We notice that the high frequency SNR degradation is less severe for the attenuated signal. This is because the associated aliasing signal noise is reduced correspondingly.

Data Capacity

From FIG. 8 it is possible to estimate the DMT bit-loading. This means how many bits can be assigned to a DMT carrier (tone) for a given signal-to-noise ratio for a particular carrier. In total, this will directly determine the overall downstream data capacity. The table below gives the relationship between SNR and number of bits that can be assigned to a DMT carrier:

| SNR [dB] | Number of bits per tone |
|---|---|
| 34-35 | 9 |
| 37-38 | 10 |
| 39-40 | 11 |
| 42-43 | 12 |

Although the maximum allowable number of bits that can be assigned to a carrier is 15, the bit-loading schemes of today's ADSL systems limit this number to 12. Therefore a SNR of 43 dB and higher is sufficient for full-rate ADSL transfer of 8 Mbps. The SNR graph given above suggests that the bit-loading would be reduced below full capacity for carriers above about 750 kHz. In practice, we see that the bit-loading remains high (11 to 12 bits) across nearly the entire downstream spectrum regardless of signal attenuation. This suggests that the signal PSD used by some modem manufactures (specifically ALCATEL) is much more stringent that that set out in the standard. This would consequently reduce the aliasing and increases the SNR.

Upstream Signal Analysis

Bandwidth

G.dmt: 25.875 kHz to 138 kHz

For full-rate ADSL, the upstream signal uses DMT tones 6-32 (FDM).

PSD Mask

The system's PSD mask must be in compliance with the PSD mask described in ANSI T1 -413, section 7.14. The ANSI standard describes the transmitter PSD for both FDM and echo cancellation modes. The system employs FDM technique, which separates downstream from upstream band. The upstream transmit PSD within 25.875 kHz to 138 kHz passband is no greater than −34.5 dBm/Hz. The passband ripple during steady-state is no greater than +3.5 dB; the maximum PSD of (−38+3.5 ) dBm/Hz applies across the whole passband from 25.875 kHz to 138 kHz. In the band from 0 to 4 kHz (POTS), the PSD is no grater than −97.5 dBm/Hz.

As mentioned the down-stream section, The system itself simply codes and subsequently reconstructs signals generated by ADSL modems. It is designed to not provide any gain across the spectrum. Thus if ANSI T1 -413 compliant modems are used, the system will not violate the standard.

Signal to Noise Ratio

The maximum signal subject to the CO AFE input is as described hereinafter. Noise is injected in the ADSL signal along the processing chain. A variety of hardware has been adopted to perform the various functions. The following is an analysis of the resulting signal to noise ratio (SNR).

DSL to Fiber

This part of the system shown in FIG. 9 includes OPE CODEC with its components: low pass filter, analog-to-digital converter (ADC), digital LPF, and downsampler.

Analog Filtering

The low pass analog filter is used to reject the near end echo and maximize the dynamic range of the ADC. The corner frequency of the filter is 138 kHz.

Quantization

The ADC's sample rate is 2.208 MHz providing 8 ×over-sampling. The SNR of an ideal A/D converter can be calculated using the following equation:

$$SNR [ dB ] = 10 log \frac{3 \cdot {2}^{2 N}}{{K}^{2}}$$

N—number of bits of ADC

K—crest factor (peak-to-average ratio of the signal); K=5 for ADSL signal

The noise introduced by ADC is called quantization noise. With a 14 -bit ADC the SNR of ADSL signal is 75 dB. This means that the quantization noise power is 75 dB below that of a full scale signal.

Digital Filtering and Down-Sampling (Decimation)

Quantization noise power can be reduced by virtue of the 8 ×over-sampling technique. The signal is sampled at 2.208 Msps, 8 ×the Nyquist rate. The quantization noise is white, so its power spectral density is constant over the frequency range [−1.104 MHz, 1.104 MHz]. Since the signal bandwidth is 138 kHz, we can pass the output signal from ADC through the digital low pass filter with cutoff frequency 138 kHz to reduce the quantization noise by 9 dB. In practice the gain is less than 9 dB since the decimation filter is not ideal and so does not completely eliminate the noise in the stop band.

Since the spectrum above 138 kHz has been suppressed, the samples could be decimated by a factor of eight by discarding all but every eighth sample. We choose however to only decimate by a factor of four in order to reduce aliasing noise. The new sample rate is 552 ksps and the noise reduction remains at approximately 9 dB. Thus the total SNR in A/D conversion is now 84 dB.

Spectral Aliasing

Because the digital filter is not perfectly sharp, it does not completely eliminate the noise in the stop band before the signal is down-sampled. Because, however, the signal is down-sampled to 552 ksps, 2 ×the Nyquist rate, only a very small amount of spectrum energy will be translated from the stop band back to the signal bandwidth (138 kHz). That means the aliasing virtually doesn't exist in the upstream path.

Numerical Truncation

Numerical truncation is explained in other sections. The SNR is thus limited to 75 dB.

Fiber to DSL

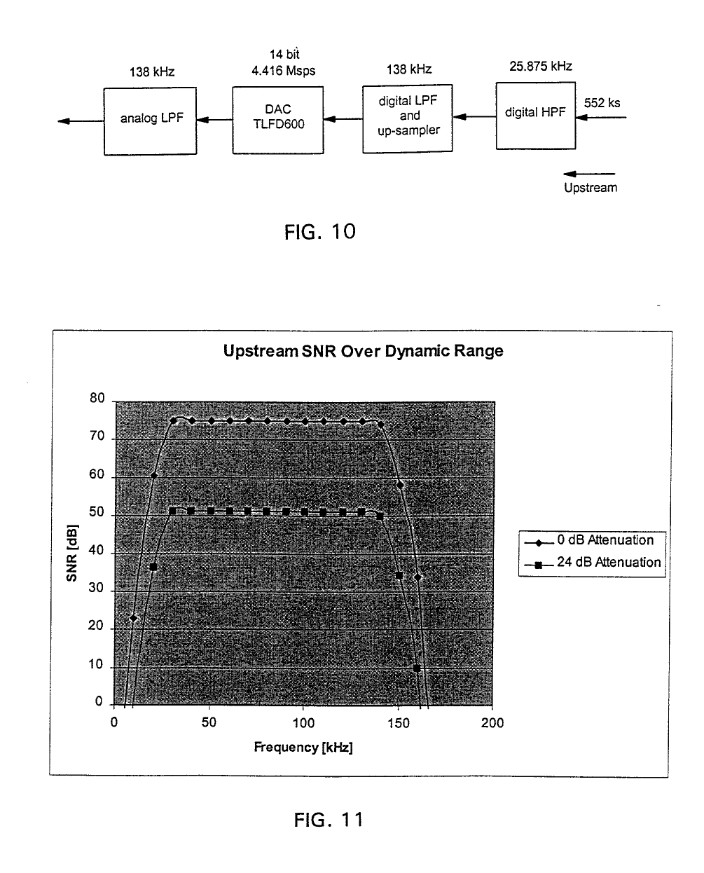

This part of the system shown in FIG. 10 includes CPE CODEC with its components: digital high and low pass filters, digital-to-analog converter (DAC), and analog low-pass filter.

Up-Sampling and Digital Filtering (Interpoation)

The digital upstream signal that comes from the fiber is at 552 ksps. It is then up-sampled to accommodate the DAC operating at 4.416 Msps. The over-sampling does not cause aliasing, but it raises the Nyquist frequency to include additional spectral copies of the signal. The copies are eliminated by a digital LPF following the up-sampler leaving only the base-band signal. The chain shown in FIG. 10 contains the up-sampling stage with digital a LPF for a 8 ×up-sampling rate.

The analog signal output from 14 bit DAC passes through 138 kHz analog reconstruction LPF in order to remove spectral copies produced by the DAC at the harmonics of the sampling rate. Over-sampling relaxes the requirement for high order reconstruction filters and reduces DAC noise.

Numerical Truncation

Numerical truncation is explained in another section. The SNR is thus limited to 75 dB.

Dynamic Range

The system is designed for distances up to 1.8 km between OPE AFE and subscriber. In the upstream SNR analysis, two cases are of a particular interest: the shortest (0 km) and the longest (1.8 km) loops. For 0 km of line the maximum power level from the CPE modem (12.5 dBm) is applied to the OPE AFE. This signal is attenuated by 14 dB so as not to saturate the ADC of the AFE. The attenuation assures that a full power CPE signal results in full-scale signal (3 Vpp) at the ADC.

For 1.8 km of the line, the signal from the CPE modem will be attenuated for 20 to 24 dB (typical attenuation of 26 AWG phone line in the upstream frequency range). Therefore, the signal at the OPE AFE input will be 20 to 24 dB smaller than the full-scale signal (3 Vpp). As it is mentioned in the downstream section, we fixed the input stage gain/attenuation regardless of the input signal level received. Therefore, for 1.8 km of the line, SNR is degraded by as much as 24 dB for a total upstream SNR of 75−24=51 dB.

FIG. 11 shows the over-all upstream SNR ratio over frequency across the dynamic range of the input signal (0 km to 1.8 km distance between a customer home and OPE AFE). We notice that the SNR characteristic is very close to the ideal SNR characteristic for 14 -bit converter (75 dB flat). There is no degradation in the upper frequency band caused by aliasing because of the higher down-sampling rate (2 ×the Nyquist rate). This reduces significantly the overlapping of spectral components. Again, the worst possible case for out-of-band signal power has been assumed in the analysis (PSD mask described in another section).

Data Capacity

From FIG. 11 it is possible to estimate the DMT bit-loading. This means how many bits can be assigned to a DMT carrier (tone) for a given signal-to-noise ratio for a particular carrier. In total, this will directly determine the overall upstream data capacity. The table below gives the relationship between SNR and number of bits that can be assigned to a DMT carrier:

| SNR [dB] | Number of bits per tone |
|---|---|
| 34-35 | 9 |
| 37-38 | 10 |
| 39-40 | 11 |
| 42-43 | 12 |

Although the maximum allowable number of bits that can be assigned to a carrier is 15, the bit-loading schemes of today's ADSL systems limit this number to 12. Therefore a SNR of 43 dB and higher is sufficient for full-rate ADSL. The SNR graph given above suggests that the maximum number of bits can be assigned to each DMT carrier in the upstream spectrum.

Communication Errors

Analog Noise (ANSI T1.413 G.dmt)

ADSL modems are designed to tolerate noise in the signal chain. The modems negotiate the bit-loading of each carrier given a particular level of channel noise. As more noise is introduced, the bit-loading of each carrier is reduced. The ANSI T1.413 G.dmt standard specifies that modems perform with a bit error ratio (BER) of 10⁻⁷ or less. The System system adds to the channel noise, and so bit-loading may be affected slightly.

Transport Bit Errors Channel noise from the signal processing that is deliberately performed on the ADSL signals was discussed above. Further, a discussion of the effect of optical bit errors follows.

An optical bit error causes the 8 B10 B decoder to yield an erroneous output value. The error translates to sample errors in the digitized ADSL signal. Since the bits of the decoded output are not mapped to any specific channel, the decoded output could span two consecutive channels affecting each to varying degrees. Up to eight contiguous bits of a channel's 14 bit sample can be corrupted.

A sample error can be viewed as impulse noise added to the analog signal. This noise degrades only that symbol in which it occurs. All DMT carriers are affected simultaneously since the Fourier transform of an impulse is flat across the entire spectrum.

Clocks

Single Direction Clocking Scheme

In a conventional ADSL system, the receiver of the ADSL signal extracts the clock from the signal and phase locks its reference clock to that signal with a voltage controlled crystal oscillator (VCXO). Thus, we have a two-clock signal chain where the two clocks are phase locked. Because the source analog signal is constructed from a clock with some phase jitter, this jitter will translate to some distortion of the ADSL signal. Also, because the receiving end of the ADSL system digitizes the received signal with a clock with phase jitter orthogonal to the source clock's, the resulting signal will have some distortion due to both clock's phase jitter. Note that ADSL is designed to tolerate these issues.

The system also uses separate clocks at each terminal. The transmitting terminal samples, digitizes, and transmits the ADSL signal based on its reference clock. The receiving terminal extracts this clock from the data stream using a phase-locked loop (PLL). The ADSL signal's reconstruction could be then based on the recovered clock. Because the jitter on each of the two clocks is orthogonal, the result would be some decrease in the signal to noise ratio (SNR).

Dual Direction Clocking Scheme

The downstream (or upstream) A/D and subsequent D/A conversions must occur based on the same clock as described above. If the downstream and upstream conversion hardware at one end had separate clocks, we could use two independent single-direction clocking schemes as described above. However, the ADSL CODEC hardware available today typically uses a common clock for both directions. A number of techniques were considered to facilitate the use of these standard CODECs.

Slip Buffer

A technique of repeating and dropping samples, known as a slip-buffer, was considered to compensate for clock frequency differences at the two terminals. However as ADSL uses quadrature amplitude modulation (QAM), the lost or repeated samples introduce by the slip-buffer cause carrier phase shifts resulting in spinning of the constellation over time.

Each ADSL QAM constellation can have up to 32768 points, therefore even the smallest rotation will cause incorrect demodulation of the ADSL data due to the small distance between points. It was, therefore, decided that a slip buffer was not an appropriate technique to implement.

Loop Timing

A technique called Loop Timing locks all system clocks to a master reference in order to prevent the problems discussed above. One terminal is chosen to be the master and the other is chosen as the slave. The master sends data to the slave based on its system clock. The slave recovers the master clock embedded in the received data. The slave uses the recovered master clock to send data the to master. Thus since all clocks are frequency and phase locked the CODEC hardware at each end can reliably use a single clock for transmit and receive.

The phase-locked loop does not have an infinitesimally narrow bandwidth, which would be the ideal case, as only the DC phase component would be preserved. However, because this is not the case, some low frequency jitter or wander introduced from noise in the communication channel and clock recovery will pass through the PLL. In IEEE 802.3, high frequency jitter is defined as any jitter above 637 kHz, and anything below this is wander. The system has been design such that the jitter requirements of the Gigabit Ethernet components are met, however the wander, while it will not affect the Gigabit Ethernet components, will have an effect on the ADSL signal. The reason for this is that the ADSL samples will be reconstructed differently than they were sampled. This will cause the time between reconstruction samples to vary, causing time compression and expansion, and spectral smearing.

The phase-locked loop has been designed with a very low closed-loop bandwidth (≅19 Hz), so the wander is very small. It has been found that this spectral smearing due to clock wander has had no noticeable effect on the system's performance.

High-speed Data

IEEE802.3 Gigabit Ethernet (1000 Base-LX)

Physical Medium Dependent (PMD) Sublayer

The PMD Sublayer of the system is the section that is responsible for the transmission of the high-speed serial data from one end to the other.

This section of the system deals with the high-speed serial data communication. This include the serializer, optical transmitter, fiber, optical receiver, and deserializer.

Serializer

The serializer is the section of The system that is responsible for multiplexing the ADSL sample data into one 1.23648 Gbps serial data stream. This data rate is derived from:

R=fs·N·n·(1+O )

where R is the data rate, O is the overhead, fs is the sampling rate, N is the bit resolution, and n is the number of channels. This gives

R=(2.208 Msps)(14 bits/sample)(32 )(1.25 )

R=1.23648 Gbps

Peak-to-Peak Clock Jitter

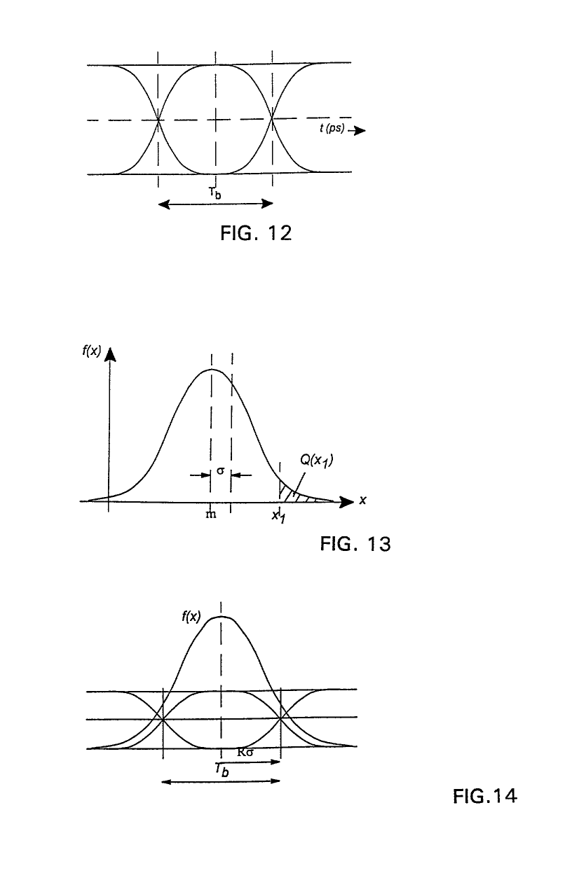

Jitter is the instantaneous phase variations of the received clock, measured in units of time (often picoseconds). As the received clock jitter increases, the probability of bit error increases. In FIG. 12 is an eye diagram, showing the eight possible trajectories of the received data for two bit time intervals.

Jitter is expressed in terms of root-mean-square (rms) jitter and peak-to-peak jitter, where rms jitter is the standard deviation of the probability density function of the jitter, and peak-to-peak jitter is the absolute time bounds within which the received clock edge will occur, specified within a confidence interval. From the above diagram, it is evident that the ideal sampling time is in the centre of the eye, and if the peak-to-peak jitter becomes larger than the bit period (T_{b}) also known as the unit interval (UI), there will be bit errors. Therefore, it is necessary to specify a reference clock with a peak-to-peak jitter that meets the specification of the serializer-deserializer (SerDes).

Peak-to-rms Jitter Ratio

Peak-to-peak jitter is the figure of merit that is most intuitive to the engineer, and is often the requirement that is specified for a clock. However, as jitter is a random variable, it is impossible to specify a peak-to-peak value, as the peak-to-peak measurement would be infinite given an infinite measuring time interval. Clock oscillator specifications therefore frequently specify jitter in terms of rms jitter rather than peak-to-peak jitter. The peak-to-peak value can then be determined by deciding on the required bit error ratio (BER) of the system. If the probability density function (PDF) of the jitter is approximated as Gaussian, then given a particular BER, the required rms jitter can be determined from the specified peak-to-peak jitter. The Gaussian distribution is given by

$$f ( x ) = \frac{1}{\sqrt{2 π} σ} {ⅇ}^{- \frac{{( x - m )}^{2}}{2 {σ}^{2}}}$$

where m is the mean and σ is the standard deviation.

The probability of an event occurring between z and ∞ is given by the Q function

$$P = Q ( z ) where$$

$$Q ( z ) ≡ \frac{1}{\sqrt{2 π}} {\int }_{z}^{∞} {ⅇ}^{\frac{- {λ}^{2}}{2}} ⅆ λ and$$

$$z = \frac{x - m}{σ}$$

A graph of the Gaussian distribution and a graphical meaning of its associated probability are shown in FIG. 13.

Density Function

When dealing with jitter, it is convenient to treat its PDF as Gaussian. If the center of the eye is the mean edge location and this is the reference point, the mean is zero. Because it is desired to find a peak jitter specification in terms of rms jitter, or a peak-to-rms ratio, z becomes the peak-to-rms ratio as follows:

$$z = \frac{x - m}{σ }$$

$$z = \frac{R σ - 0}{σ}$$

$$z = R$$

where R is the peak-to-rms ratio.

R must be chosen such that the timing jitter does not cause the BER to exceed the system's requirements, which is 10⁻¹² for The system (Gigabit Ethernet PMD Sublayer IEEE802.3 ). This means that the probability of a clock edge occurring outside the bit period region, T_{b} , must be less than 10⁻¹² . Because z is the peak-to-RMS ratio, the correct z must be found for a BER of 10⁻¹² . The Q function has no closed-form because the integral of the form

∫e^{x}^{²} dx

has no closed-form solution, and one must resort to numerical solutions. However, the following approximation may be used for large values of z:

$$Q ( z ) \approx \frac{1}{\sqrt{2 π} z} {ⅇ}^{\frac{- {z}^{2}}{2}}$$

for z≧3

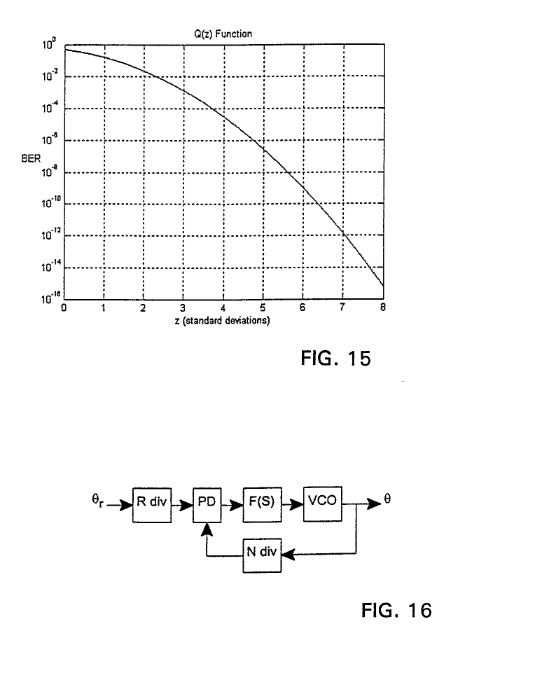

A graph of the Q function is given in FIG. 15. From the graph, it can be found that, given a BER of 10⁻¹² , the required z is about 7. Therefore, the peak-to-rms ratio, R, for the reference clock oscillator must be 7 or greater. Therefore, the peak-to-peak to rms ratio must be greater that 14.

Deserializer

Recovered Clock Jitter

Through each stage of the serial communication link, jitter is added to the transmitted clock. The added jitter, which consists of both random and deterministic components, is tolerable as long as the total added jitter does not exceed the jitter budget. As soon as the jitter exceeds one bit period in peak-to-peak measures, the jitter budget is exceeded. For Gigabit Ethernet, jitter budget is 800 ps. So long as the received clock's jitter is not greater than 800 ps, successful bit reception can be assured. Because The system's design adheres to the Gigabit Ethernet standard for the PMD Sublayer, this criterion is met.

8 B/10 B ENDEC

The Gigabit Ethernet PMD Sublayer uses a signalling standard developed by IBM knows as 8 B/10 B encoding. This technique encodes an 8 bit word as a 10 bit word and provides a DC balanced data stream. It allows for easier clock recovery than would be allowed by an unencoded stream. The system uses this scheme, which is performed by the programmable logic, and allows for compatibility with Gigabit Ethernet compliant parts. As well as maintaining DC balance, and allowing for easy clock recovery, the 8 B/10 B scheme also provides for special signalling, as a set of codes correspond to special characters, known as K characters. This characters are useful for channel synchronization and system protocol implementation. Also because only a certain set of codes is valid, often bit errors can be detected as they may result in invalid codes. This coding scheme introduces a 25 % overhead.

Bit-Error Ratio

The BER for The system was designed to be that of Gigabit Ethernet in the IEEE 802.3 standard. This specification is 10⁻¹² , and will not cause the ADSL system to have a BER of less than 10⁻⁷ . In order to adhere to the IEEE 802.3 standard, all parts in the PMD Sublayer were chosen to conform to this standard.

Crystal Controlled Clocks

The loop-timing scheme described above solves the problem of using single clocked CODEC hardware; however a problem arises when considering clock jitter. The clock is recovered from a high-speed (1.23648 Gbps) data stream. Because of the high speed, extremely low jitter is required for the reference source. The recovered clock at the slave end will have relatively high jitter due to the injected noise and clock recovery mechanism, and will not meet the specifications for the serializer-deserializer (SerDes) at the slave end. Therefore, the recovered clock cannot be simply looped back to the reference clock. The clock jitter must first be filtered. This is accomplished by means of a phase-locked loop (PLL) with an extremely low bandwidth. Because the loop has a very low bandwidth, it is slow to respond to input phase changes, thus removing most of the received clock jitter. After the received clock's jitter has been filtered, it can then be used to send data back to the master.

The PLL used in The system is a type II, third-order loop. Because it is a type II loop, there is zero steady-state phase error between the reference and output clocks. This makes the use of the two clocks in the programmable logic simpler, as it gives a known phase relationship between the two. Also, because the closed loop response is of third-order, the low-pass frequency response has a very steep roll-off.

All of the clock oscillators used in The system are low-jitter, crystal oscillators. This assures that a highly stable source is used, with a jitter figure that lies within the design specifications.

Master Transmitter Clock

The master transmitter clock is a clock oscillator with low jitter. Its frequency is 123.648 MHz and is used as the reference clock for the loop-timing scheme.

Slave Receiver Clock

The slave receiver clock is the recovered version of the master transmitter clock. This clock is recovered by the SerDes receive section, and is exactly the same frequency of the master transmitter clock, but with significantly higher jitter.

Slave Transmitter Clock

The slave transmitter clock is the jitter-filtered slave receiver clock. By using the slave receiver clock as the reference source for a very narrow band PLL, the output of the PLL is phase locked to the reference, but has the jitter characteristics of the VCXO used in the PLL. The VCXO, therefore, is specified with very low jitter.

Master Receiver Clock

The master receiver clock is the recovered clock sent by the slave. This clock is phase locked to the master transmitter clock, due to the loop timing, but has added phase jitter. It is used as recovered without any filtering.

Protocol

The system uses a specialized transmission protocol to provide for reliable channel order, recovery from power cycling, and recovery from fiber disconnection and reconnection. This protocol makes use of some of the special K characters provided by 8 B/10 B for signalling. The use of these characters is given below.

Commas

Commas are used in The system as an idle character. This is the K28.5 character from the 8 B/10 B standard. The SerDes chip uses the comma character for frame synchronization, thus it is used to synchronize the communication channel and to allow the PLL to lock before any negotiation occurs. The master end also uses commas as a resynchronization character.

Start of Packet

The start of packet (SOP) character is the K27.7 character from the 8 B/10 B standard. The purpose of this signal is to signal the receiving end that the first data to follow the SOP character is the first byte of the first ADSL channel. This character is necessary for channel ordering and synchronization.

Data Format

The channel data format that The system uses is 2 's complement, 14 bit linear pulse code modulation (LPCM) at 2.208 Msps.

Four channels (designated 0, 1, 2, 3 ) can be addressed on a single parallel bus. Eight independent parallel buses are managed by two FPGAs (U1 and U2 ). Each FPGA handles four of eight buses (designated A, B, C, D). Each FPGA generates a serial data stream of its associated channels sent most significant bit first. Channels are ordered sequentially according to the data access needs of one of the analog front end (AFE) chips employed (the Texas Instruments TLK320 AD16 ). The two data streams are merged and interleaved 8 bits at a time (U1 first) before being transmitted down the Gigabit Ethernet PMD. The channel sequence of each FPGA is as follows:

U1 sequence: 24, 32, 17, 25, 23, 31, 18, 26, 22, 30, 19, 27, 21, 29, 20, 28

U2 sequence: 8, 16, 1, 9, 7, 15, 2, 10, 6, 14, 3, 11, 5, 13, 4, 12

The channels are arranged in an interleaving process:

The correspondence between schematic reference designator (Jx), programmable logic verilog reference, and user channel number is as follows:

PCB J1 →FPGA U2,A→Channel 8, 7, 6, 5

PCB J2 →FPGA U2,B→Channel 16, 15, 14, 13

PCB J3 →FPGA U1,A→Channel 24, 23, 22 ,21

PCB J4 →FPGA U1,B→Channel 32, 31, 30, 29

PCB J5 →FPGA U2,C→Channel 1, 2, 3, 4

PCB J6 →FPGA U2,D→Channel 9, 10, 11, 12

PCB J7 →FPGA U1,C→Channel 17, 18, 19, 20

PCB J8 →FPGA U1,D→Channel 25, 26, 27, 28

Although the upstream path requires only one fourth the data rate as the downstream path, all 2.208 Msps are transmitted filling the entire upstream pipe.

Hardware

Data Framing

Data framing information is embedded in the transmit data streams (up and down) to assure channel synchronization. The framing information is continuously scrutinized at the receiving end to assure that channels arrive in the correct order. Downstream channel-data occupies 100 % of the available bandwidth. Traditional serial communication overhead bits could have been added at the expense of the number of channels supported; however, the embedded framing approach allowed us maximize the number of channels at the expense of a very small decrease in the signal fidelity for that channel.

Not all channels require the framing information to keep the system synchronized. Instead, each of the system's two field programmable gate arrays (FPGA) needs only one framing channel. Therefore two of 32 channels contain the framing information.

Happening once each ADSL symbol period (250 us), the least significant bit (LSB) of one sample of the selected channel carries the embedded framing information. Here the digital value of this bit is overridden by the current value of a known pseudo random bit stream (PRBS).

We implemented maximal length sequences using a four bit linear feedback shift register (LFSR) yielding a 15 bit length PRBS. Two independent sequences are used (one for each FPGA). The same sequence is used for both upstream and downstream directions for a particular channel. The sequences are defined by the following equations: X0 =X3 XNOR X4, and X0 =X1 XNOR X4 . Both sequences are seeded with all zeros.

The receiving end discriminates against invalid framing by comparing the received stream with a locally generated stream. The discriminator monitors a moving window of the four most recent bit comparisons and tolerates no more than one bit error in the window. This tolerance level is high enough to allow an isolated transport related bit error incident which would occur only rarely based on the IEEE 802.3 Gigabit Ethernet standard's required bit error ratio of 10ˆ -12. The probability of a second transport related bit error seen at the exact right bit time (one of the four window bit positions) purely by chance is extremely low and so is ignored. Instead we treat the case of two or more errors in the window as a framing error and therefore take corrective measures.

Measurements of the ADSL performance of channels with embedded framing indicate no channel degradation.

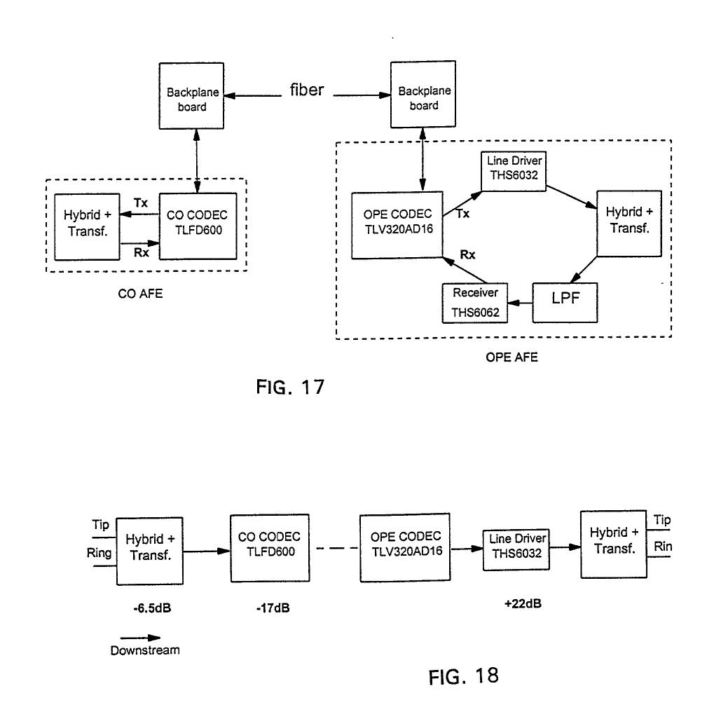

FIG. 17 illustrates a block diagram of the system hardware. Backplane printed circuit boards (PCB's) terminate a length of a pair of fiber optic cables. Analog front end (AFE) cards, unique to each terminal, connect to each backplane in order to provide the required signal processing. The following sections detail the specifics of each block.

Back Plane Specifics

The outside plant back plane is the loop timing master reference and so its time base is derived from a crystal oscillator.

The outside plant terminal is rated for extended temperatures, and so the back plane components must be industrially rated. The only exception is the Agilent HFCT-53 D5 laser transceiver module that is only available in commercial temperature grade (0 ° C. to +70 ° C.). Note however that a laser transceiver module from Sumitomo has been found that, although only commercially rated, the factory assures us that it will operate properly from −40 ° C. to +75 ° C. That part is the Excelight SMD7104 -XC.

The Xilinx XC2 S100 FPGA's provide ample programmable logic to satisfy the needs of the outside plant application. Consequently this device was selected.

Analog Front End

The OPE AFE consists of five functional blocks that are shown on right side of FIG. 17. It provides required filtering and gain, A/D and D/A conversions, as well as T/R interface through a hybrid circuit and transformer. The OPE AFE is used on customer side of The system. Two input signals to the OPE AFE are the analog ADSL signal from the subscriber, and the digital signal from the programmable logic. Two output signals are the analog ADSL signal sent to the subscriber, and digitized ADSL signal sent to the programmable logic.

TLV320 AD16 PZ (3.3 -V Integrated ADSL Codec)

The Texas Instruments TLV320 AD16 is a high-speed low power coder/decoder (codec) for central office-side (CO) discrete-multitone (DMT) based asymmetric-digital subscriber line (ADSL) access that supports full rate ADSL applications. The TLV320 AD16 is composed of five blocks: Tx, Rx, clock, reference and interface. The Tx channel consists of selectable digital filters, a 14 -bit, 8.832 -Msps DAC, a 1.104 MHz analog low-pass filter (LPF) and a Tx attenuator. The Rx channel consists of three PGAs, a 138 -kHz analog LPF, a 14 -bit, 2.208 -Msps ADC, and a 138 -kHz digital LPF. The data rate can be software selected and the chip generates a 1.5 V reference. A parallel port is used for data transfer and a serial port for programming. Operating temperature is from −40 ° C. to +85 ° C.

THS6032 IDWP (Low-PowerADSL Central-Office Line Driver)

The Texas Instruments THS6032 is a low-power line driver ideal for ADSL applications. This device contains two high-current, high-speed current feedback amplifiers, which can be configured differentially for driving ADSL signals at the CO side. The THS6032 also features class-G architecture, which lowers the power consumption to 1.35 W. Operating temperature is from 40 ° C. to +85 ° C.

THS6062 IDGN (Low-Noise ADSL Dual Differential Receiver)

The Texas Instruments THS6062 is a high-speed differential receiver designed for ADSL applications. It is a voltage-feedback amplifier with a 100 MHz bandwidth and a 100 -V/μs slew rate. The THS6062 has a noise margin of 1.6 nV/√Hz, which provides the high signal to noise ratios necessary for the long lengths of copper lines. Operating temperature is from −40 ° C. to +85 ° C.

Hybrid Circuit

The hybrid is a three-port network intended to pass the signal from the line driver to the loop, from the loop to the CODEC's receive port, and to isolate the receive port from the line driver power. The best coupling from the line driver to the loop is −3 dB; half of the transmitted signal power from the line driver is lost in the hybrid. The transformer that is used is an ADSL transformer with 1:2 turns ratio.

Low Pass Filter (LPF)

Third order elliptical filter is used in the upstream path to filter out the frequencies above 138 kHz. The filter helps the line receiver not to be saturated by a big unwanted downstream signal from the line driver. The filter is designed for input impedance of 1400 Ω, and output impedance of 10 Ω.

Central Office

Back Plane Specifics

The central office back plane is the loop timing slave and so its time base is implemented with a voltage controlled crystal oscillator as part of a phase locked loop.

The central office terminal is rated only for commercial temperatures, and so the back plane components can be commercially rated.

The Xilinx XC2 S150 FPGA's provide ample programmable logic to satisfy the needs of the central office application. Consequently this device was selected.

Analog Front End

The CO AFE is shown on left side of FIG. 17. It also provides A/D and D/A conversions, gain and filtering, and T/R interface to DSLAM. The inputs are the ADSL signal from the CO DSLAM, and the digital signal from the logic. Consequently, the outputs are the analog ADSL signal that is sent to the DSLAM, and the digitized ADSL signal that is sent to the programmable logic.

TLFD600 PAP (ADSL Codec with Integrated Line Driver and Receiver)

The Texas Instruments TLFD600 is a high-speed, programmable, analog front end for customer premise equipment (CPE) modems that support full rate ADSL. This device incorporates both the line driver and receiver. The TLFD600 performs D/A, A/D, transmit and receive filtering, equalizing and programmable gain amplification (PGA). The receive channel has a data rate of 2.208 Msps. The transmit channel has a data rate of 552 ksps. Both data and control lines share a serial port. The operating temperature ranges from −40 ° C. to +85 ° C.

Hybrid Circuit

The hybrid is a three-port network intended to pass the signal from the line driver to the loop, from the loop to the CODEC's receive port, and to isolate the receive port from the line driver power. The best coupling from the line driver to the loop is −3 dB; half of the transmitted signal power from the line driver is lost in the hybrid. The transformer that is used is an ADSL transformer with 1:2 turns ratio. Note: The line driver is integrated with CODEC in TLFD600.

System Gains

Downstream Channel Gain/Attenuation

The downstream signal from a DSLAM is attenuated/gained by the various blocks in the system as shown in FIG. 18. The goal is to achieve 0 dB attenuation/gain through the system (from T/R to T/R).

The first block is the transformer with the hybrid circuit. The transformer's turns ratio is 2:1 resulting in signal attenuated of 6 dB (if perfectly matched to the line). The hybrid does not introduce any additional attenuation in the downstream path. Due to non-ideal matching however, 6.5 dB of loss is measured in the lab (as shown in FIG. 18).

The TLFD600 's downstream (receiver) channel consists of a coarse programmable gain amplifier (CPGA), analog high-pass and low-pass filters, two programmable gain amplifiers, ADC, and a digital filter. As explained in the downstream channel analysis, the largest T/R signal from a DSLAM (max. 37 Vpp) must be attenuated by at least 21.8 dB to prevent the ADC's 3 Vpp full scale range from being saturated. Because we already have 6.5 dB of attenuation in the transformer, an additional 15.3 dB must be introduced by TLFD600's CPGA. 17 dB was chosen to allow a safety margin. We implemented the attenuation by changing input stage resistor/capacitor combination and keeping the CPGA at the default setting. Note that although the data sheet shows the default gain as 9 dB, the factory concurred with our finding of 11 dB to 13 dB.

The next block in the system is TLV320 AD16, which doesn't introduce any attenuation/gain. Its downstream (transmit) channel consists of digital filters, 8.832 MSPS DAC, low-pass filter, and a transmit attenuator. The attenuator is set to 0 dB (by default).

The THS6032 line driver is designed to amplify the signal by 22 dB.

The last block in the chain is the hybrid circuit along with the transformer. It provides T/R interface to the customer line. There is no attenuation/gain in this block in the downstream path.

The resulting signal path gain is the sum of the individual block gains. This is nominally −1.5 dB but varies slightly with components. In practice we see variation of less than +/−0.5 dB typically.

Upstream Channel Gain/Attenuation

The upstream signal from a customer is attenuated/gained by the various blocks in the system as shown in FIG. 3. The goal is to achieve 0 dB attenuation/gain through the system (from T/R to T/R).

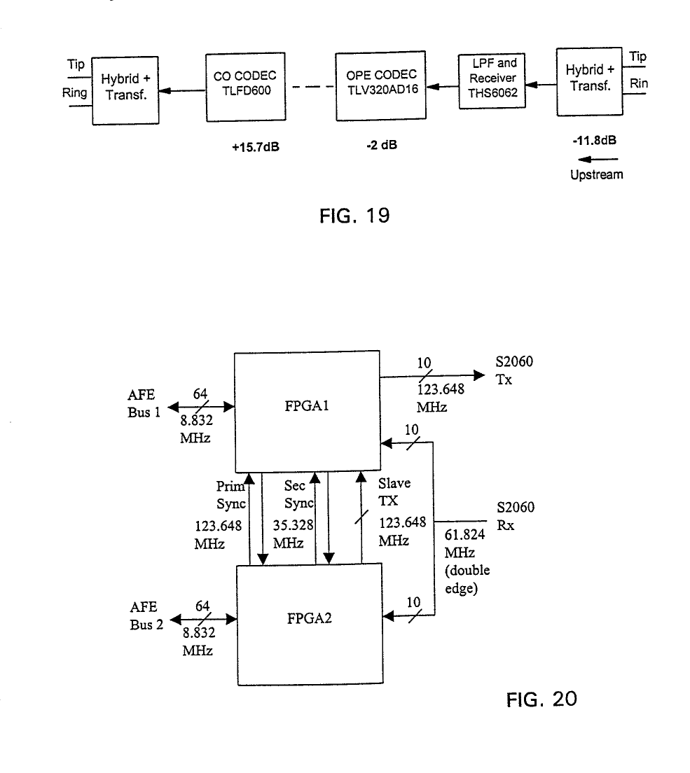

As shown in FIG. 19, the transformer and hybrid circuit introduce a total of 11.8 dB of attenuation. The transformer alone attenuates the signal amplitude by 6.5 dB and the rest (5.3 dB) is due to the hybrid (3.5 dB if perfectly matched to the line).

The LPF and the line receiver (inverting amplifier with unity gain) are designed to introduce no attenuation/gain in the signal path.

The TLV320 AD16 upstream channel consists of a coarse programmable gain amplifier (CPGA), analog low-pass filter, two programmable gain amplifiers (PGAs), ADC, and a digital filter. The received signal from the hybrid circuit needs to be attenuated an additional 2 dB in order to protect the ADC from saturation. The CPGA is set up at −8 dB, and PGA1 is set up at +6 dB. We implement this by programming two TLV320 AD16 's registers as follows:

SCR8 : (105 D)₁₆

SCR2 : (0406 )₁₆

The TLFD600 CODEC has an integrated line driver with a fixed gain of 15.7 dB. This provides a maximum drive of 18.2 Vpp differential output when the input is 3 Vpp (maximum range from the DAC). Thus, a transformer with 1:2 ratio is implemented in the following block along with the hybrid circuit. The overall attenuation of the block is 0 dB.

The TLFD600 FMR register must be programmed for the proper full-rate ADSL operation as follows:

FMR: (02 )₁₆

The resulting signal path gain appears to be +1.9 dB (more that the 0 dB goal); however, lab measurements show that this value is necessary to compensate for some circuit attenuation not yet accounted for. The line receiver or analog filter may be responsible for the attenuation.

Programmable Logic

System

Terms and Abbreviations

Downstream—This is the high speed direction of the ADSL link. The end user usually requires a fast download speed, thus he is downstream from the Central Office.

Upstream Link—This is the low speed direction of the ADSL link. The end user usually requires a slower upload speed, thus the Central Office is typically upstream of the end user.

Central Office Mux (CO MUX)—the ADSL module on the upstream side of the ADSL link, typically located in the Central Office. This module can accommodate up to 32 channels and consists of a back plane board and analog front end daughter cards. The programmable logic is located on the back plane board.

Outside Plant MUX (SAC MUX)—the ADSL module on the downstream side of the ADSL link, typically located outside the Central Office. This module can accommodate up to 32 channels and consists of a back plane board and analog front end daughter cards. The programmable logic is located on the back plane board.

8 B10 B—encoding & decoding scheme patented by IBM (CT has received exemption from IBM as patent runs out in 2001 ) that allows a bit balanced transmission of serial data. This facilitates the recovery of serial clocks, etc. U.S. Pat. No. 4,486,739.

Control Characters—provision is provided in the 8 B10 B scheme to send non-data characters in the channel in order to control the link. The ADSL uses three of these characters IDLE 1=K28.5, Start_of_Packet=K27.7, Error_Propogation=K30.7

COMMA—equivalent to IDLE 1=K28.5

SOP—equivalent to Start_of_Packet=K27.7

BREAK—equivalent to Error_Propogation=K30.7

PLL—Phase Lock Loop

DLL—Delay Lock Loop

Programmable Logic Components

The programmable logic is used to organize and coordinate the functionality of the ADSL product. This logic:

controls a phase locked loop that recovers the master clock (in the CO MUX)

controls the fiber transceiver section

sets up and maintains the SAC to CO data link

codes and decodes data using 8 B10 B

creates a 35.328 MHz clock for the AFEs

programs and controls the analog front ends

buffers and distributes data to and from the AFEs

hardware dependent logic functions

The SAC and CO MUXes perform essentially the same function but the implementation needs to be different. Since the transmission is asymmetrical the CO MUX controls TLFD 600 AFE's and the SAC MUX controls the required number of AFE's. Frequency lock must be maintained across the system; to accomplish this the SAC MUX generates its own master clock while the CO MUX locks to the SAC's clock via a Phase Lock Loop. This is described in more detail in the following sections.

The fiber transceiver is used to transport Gigabit Ethernet data on an optical fiber. The programmable logic interfaces to the fiber channel via an AMCC S2060 Gigabit Ethernet Transceiver. The AMCC transceiver performs many functions including parallel to serial and serial-parallel coversions, clock recovery, clock generation, data framing, etc. The critical signals provided by/to the AMCC transceiver include 10 bit parallel data to transmit, 10 bit parallel data received, and COMMA detected. Setup signals provided ensures the chip will operate in full receive speed, will frame 10 bit words using the COMMA, and will be in normal operation mode rather than mirroring the TX data on the RX data bus.

The programmable logic implements a state machine that controls the data link's formation and teardown. On power up the SAC MUX state machine starts sending COMMA control characters to the CO MUX. The CO MUX locks its clocks to the received data signal and then signals its presence by sending COMMAs of its own. Once the SAC MUX has received sufficient COMMAs to indicate a stable link, the SAC MUX sends a pair of SOP characters followed by the channel ordered data stream. The CO MUX receives the SOP pair and uses these to synchronize the data collection. The CO MUX then sends its own SOP pair followed by data. The SAC MUX receives the SOP pair and uses these to synchronize its received data, concluding the link negotiation. If at any time the link fails, errors in the data stream will be detected causing a teardown/renegotiation. If the CO MUX wants to tear down the link it begins to send BREAK signals to the SAC MUX and starts to look for COMMAs (restarts its state machine). If the SAC MUX receives BREAKs or wants to tear down the link it renegotiates by sending COMMAs and restarting its state machine. If the SAC MUX receives COMMAs the SAC recognizes a renegotiation and restarts its state machine. Each state machine is described in more detail in the following sections.

The 8 B10 B encoder transforms byte oriented data collected from the AFEs into an appropriate bit balanced serializable data stream.

The AFEs' clocks are generated using a gated clock configuration that divides the 123.648 MHz clock down to 35.328 MHz. This clock could also be generated using on-chip DLL resources.

The AFEs should have their gains modified, the transmission rates set, etc. to allow operation in the ADSL design. On power up each AFE is programmed appropriately.

FIFO schemes were used to buffer data for fiber transmission and reception. The CO and SAC MUXes differ greatly and are described below. Diagnostic and other hardware functions can be added to the system later by: stealing sample bits, borrowing a channel, sending a control character delimited data stream, etc.

Outside Plant

Programmable Logic System Function

The function of the programmable logic, shown schematically in FIG. 20, in the OPE MUX is to interface between 32 TLV320 AD16 AFEs and the S2060 gigabit Ethernet transceiver. Each set of 16 AFE's are synchronized, and can be viewed as a 64 bit tri-state bus. Each FPGA interfaces to its own set of 16 AFEs. FPGA1 performs all transmission communication with the S2060, and both FPGAs perform reception communication with the S2060. FPGA2 sends its transmission data to FPGA1. A block diagram of this system is given below. Four synchronization lines are used for the synchronization of the two FPGAs. One pair is for synchronization 35.328 MHz based logic, and one for 123.648 MHz based logic, which includes clock generation. The synchronization operates as follows. Synchronization occurs after the internal DLLs lock. The first synch stage is for synchronizing the 35.325 MHz and 61.824 MHz clocks. When the slave FPGAs master DLLs lock, it sets a line high, and the master responds with a pulse once its DLLs lock, which are used to synchronize the clock generation logic. Then once the secondary DLLs lock, a second pulse is sent to reset 61.824 MHz based logic, and a second line is set high to reset 35.328 MHz based logic.

Programmable Logic Operation

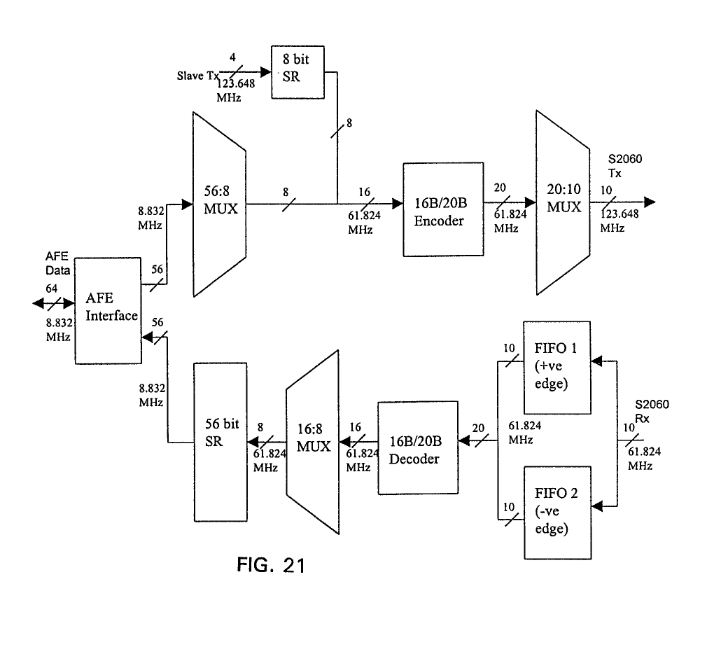

The system or peripheral functionality of the programmable logic has been briefly described, but it is, however, important to describe the internal operation of the programmable logic, as shown schematically in FIG. 21. The operation of the programmable is sufficiently complex that it requires its own system description. The main purpose of the programmable logic is to take digitally encoded samples from 32 ADSL signals and multiplex them on to one 10 bit, 8 B10 B encoded data stream. As well, it provides for the demultiplexing of 8 B10 B encoded data to 32 channels of digitally encoded ADSL.

Conceptually, the data flow through the master FPGA is given above. The TLV320 AD16 Interface block provides for the communication between and programming of the TLV320 AD16 analog front end ICs. In the transmit path, the 56 bit data received from the AFEs is multiplexed into 8 bit words where it is merged with the 8 bit words from the slave FPGA. The data received from the slave FPGA is 4 bits wide, therefore it is necessary to use a shift register to demultiplex to 8 bits. The resulting 16 bit word, therefore, consists of an MSB belonging to the master FPGA and an LSB belonging to the slave FPGA. This 16 bit word is then 16 B/20 B encoded to provide for compatibility with AMCC S2060 serializer/deserializer IC. A 16 B/20 B encoder was chosen ahead of an 8 B/10 B encoder because of the reduced clocks speed requirement of the 16 bit version. However, because the S2060 interface is 10 bits at 123.648 MHz, the 20 bit encoded data needs to be multiplexed on to a 10 bit bus before exiting the FPGA.

In the reception direction, the reverse functionality is implemented. The S2060 provides a recovered clock and 10 bit data which is valid on both edges of the recovered 61.824 MHz clocks, giving an effective throughput of 123.648 MHz. Because the recovered clock is has a constant, but unknown phase relationship with the transmit and system clock, a FIFOs is required for each edge of the recovered clock. These are implemented using dual-port RAM, and allow two frequency locked (but not phase locked) clocked to read from and write to the RAM, providing that there is some buffer between the read and write RAM addresses. The outputs of each FIFO are then merged to give 20 bit data to be input to the 16 B/20 B decoder. The decoder then gives 16 bit sample data, where each 8 bit word belongs to an FPGA. The 16:8 MUX is used to select the correct 8 bit word and is set only after end to end system synchronization. The means by which this decision is made will be described along with the manager FSM/communications protocol section. After the 16:8 MUX, the 8 bit received data is loaded into a 56 bit shift register to be transmit to the AFEs.

The operation of the slave programmable logic is a subset of the master logic. The only difference is the transmit chain. Instead of the 16 B/20 B encoder, the 8 bit data is multiplexed on to a 4 bit path where it is sent to the master FPGA where the two 8 bit words are merged.

Manager FSM/Communications Protocol

The manager finite state machine (FSM) 75 in FIG. 4 manages the entire system as well as the system protocol. This provides for the establishment of a reliable communications channel, proper data ordering, graceful recovery from power failure, system reset, fiber connection, etc., and allows for a robust system. A state diagram for this FSM is given below.

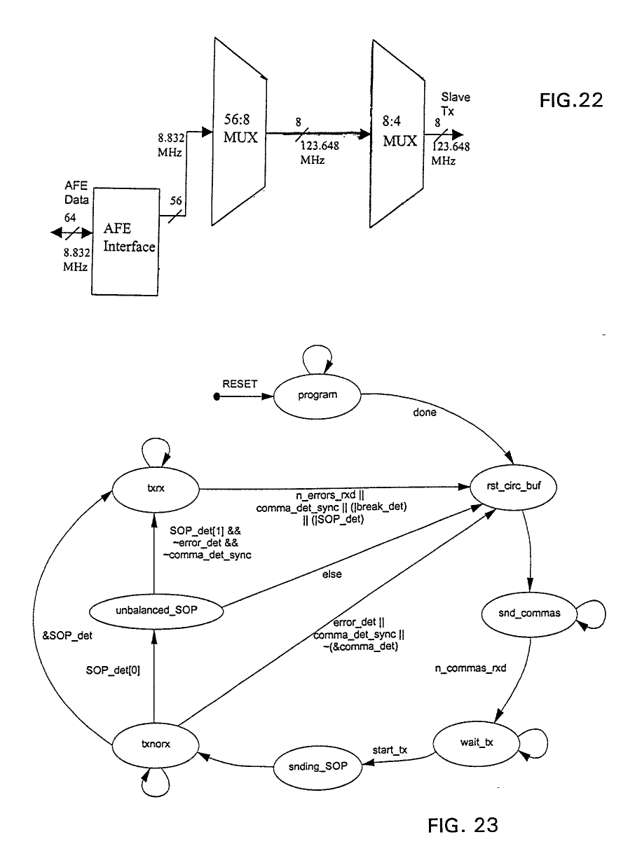

The manager FSM consists of 8 states shown schematically in FIG. 22. The first state is the program state. This is basically a dummy state that waits until the AFEs have been programmed. Then the state moves to the reset circular buffer state. This resets the circular buffer to ensure that the read and write addresses do not conflict, and does not allow the circular buffer to start until valid commas are received from the S2060. The machine only exists in the rst_circ_buf state for one 62.384 MHz clock cycle, and then it moves to the send commas state, where is simple sends commas. It remains in this state until a certain number of commas have been received in a row with no errors. The value of this was chosen to be 2²⁴ or about 17 million commas. Such a large number was chosen in order to stabilize the protocol and ensure complete integrity of the communications channel before sychronization is attempted. After this occurs, the state advances to the wait to transmit state. In this state, the machine waits for a signal from the AD16 receive logic that indicates when the first byte from the first channel is ready. Once this signal is received, the state advances to the sending start of packet (SOP) state. The start of packet character is used to indicate to the receiving end that the data to follow the pair of SOPs will be the first byte from the first channel, which allows for proper data ordering and proper channel ordering. After the SOP is sent the state machine advances to the transmit no receive state. In this state, the OPE side is sending ADSL samples to CO side, but receiving only commas. The state machine remains in this state until it receives an SOP pair, however it can return to the rst_circ_buf state as well. This will occur if one of the three conditions occur. The first is if a 16 B/20 B error is detected which can be either a disparity error or a code violation. The meaning of these terms can be found in the 8 B/10 B standard. The second condition is if the comma detect pin from the S2060 produces a pattern indicative of a loss of sync. The pattern should be, at this state of the protocol, either all ones or consecutive zeroes cascaded with all ones. The pattern that is used to detect loss of frame sync is a 101 pattern which should not occur if the S2060 has frame synched, but will very quickly occur is there is no synch. The final way that the state can return to the rst_circ_buf state is if no SOPs are detected and a comma is not detected. Before receive a SOP pair, the only valid character for the protocol is a comma. In order to advance from the Tx_no_Rx state, there are two conditions. The first is if both bits of SOP_det are high, indicating that both bytes of the 16 bit word are a SOP. Then the first data will be the msb for the next word for the master and the Isb for the slave. The state will then advance to the full transmit and receive state. The second condition is if the lsb of the received word is a SOP but not the msb. This will cause the state to advance to the unbalanced SOP state. If the msb of the received word is a SOP but not the lsb, this is invalid, and the state will return to the rst_circ_buf state. This issue of the balanced vs. unbalanced SOP is shown below. Each block is a received word and is divided between most significant and least significant bytes.

Depending on the balanced or unbalanced SOP case, the receive MUX is set to correspond to the correct byte and is opposite for the master and slave FPGAs. After the SOP is received, in either case the system advances to the full transmit and receive mode. This is the steady state condition of the state machine. The only way to exit this stage is if a break is received (error propagation from the CO end), a invalid comma pattern from the S2060 (no commas should ever be receive in this state), a SOP is detected, or if three errors in a row are received. If one of these should occur, the system returns to the rst_circ_buf state. Under normal conditions, The system should remain in this state for extremely long periods of time. Except for power failures, resets, or optical link loss, this should always be the state of the manager FSM.

TLV320 AD16 Interface

For detail as to how the AD16 interface operates such as timing, please refer to the data sheet. However, the timing diagram for the interface The system uses will be shown, as it requires that both transmit and receive be able to occur in the same time slot. This diagram is shown below.

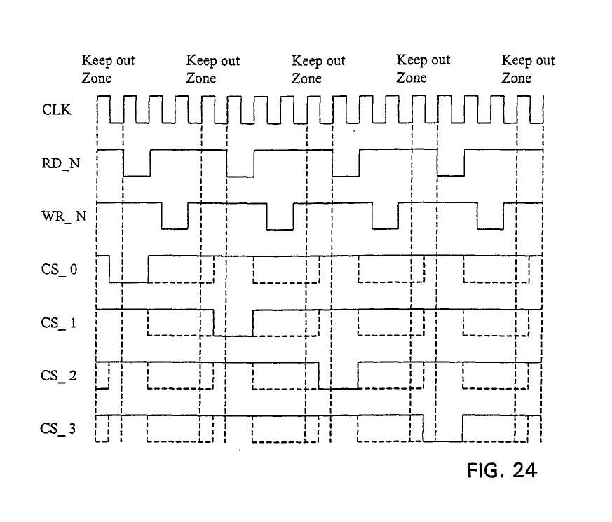

FIG. 24 shows the complete read/write cycle. The dotted sections of the chip select signals represent the fact that reading and writing can happen on any combination of channels in the same time slot. The keep out zones show the region where RD_N and WR_N should not be active.

Central Office

Central Office MUX Programmable Logic

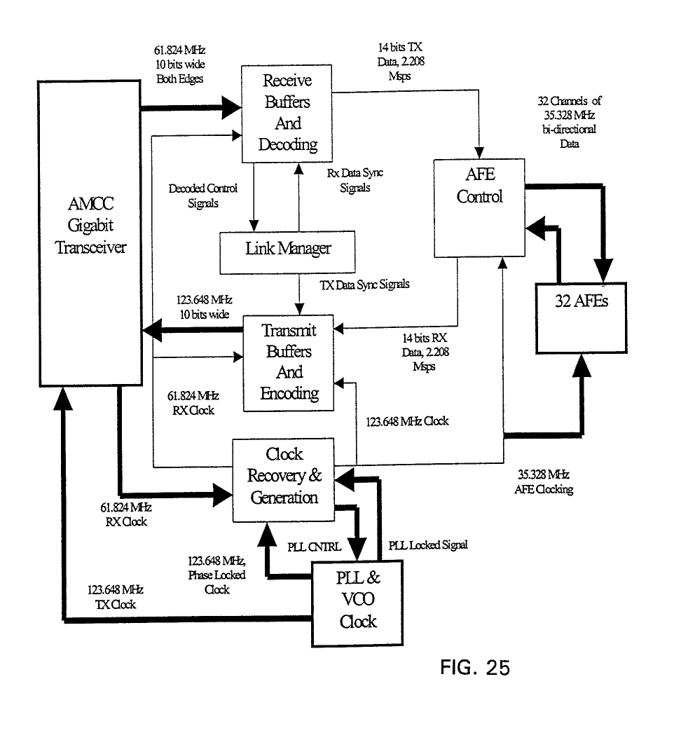

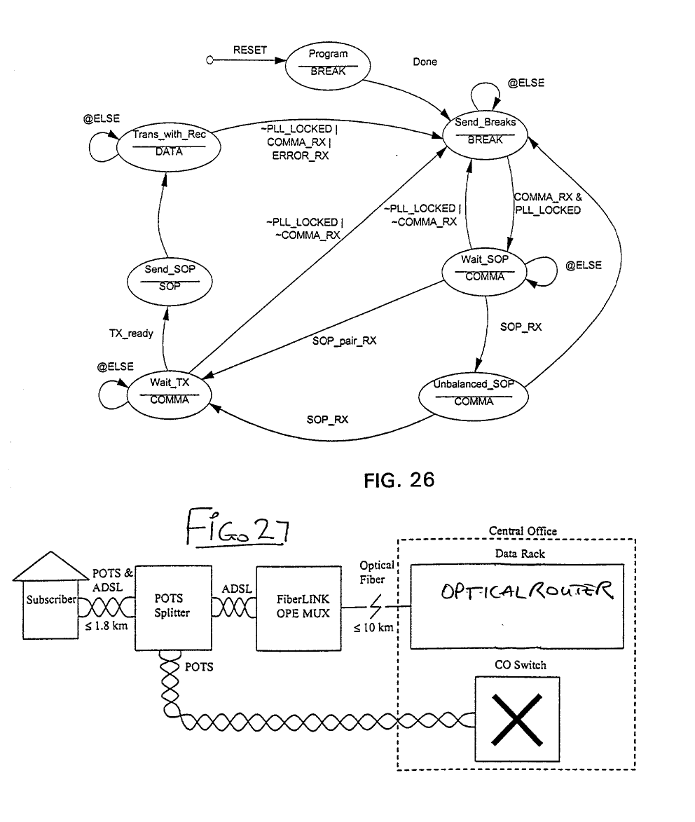

A block diagram of the programmable logic functions for the CO MUX is shown in FIG. 25. The logic has been divided into a number of blocks which expand on the system design outlined above. The blocks shown in heavy weight lines are elements external to the logic implementation. Heavy weight arrows are data flows into or out of the logic device whereas lightweight arrows are internal data flows.

TLFD600 AFE Control

The TLFD600 AFE control section performs three functions: AFE programming, sending data to the AFE from the receive buffers, and sending data to the transmit buffers from the AFE. This section collects serial data from the TLFD600 and formats it as 14 bit parallel data that is sent to the transmit buffer. A new 14 bit word is available every 16 clock (35.328 MHz) cycles. This data must be transferred from the AFE's 35.328 MHz clock to the chip system's internal 61.824 MHz clock. This is done by buffering the 14 bit data, delaying the FSX signal then coverting the FSX signal glitch free to the internal clock. The signal is then used as an enable on a register running on the internal clock. The data may be latched once or twice due to the clock mixing but will now be valid on the internal clock.

Fourteen bit wide receive buffer data fis also used by this section. This data is converted to serial data sent to the AFE every 64 clock (35.328 MHz) cycles. The FSR signal indicates that data will be soon picked up by the AFE. This signal is thus mixed from the AFE clock to the internal clock like the FSX signal. However, a register one-shot is introduced to ensure that a pulse of one clock cycle width is created. This mixed FSR signal is used as a clock enable to move the receive data from the internal clock to the AFE clock.

The TLFD600 analog front end must be programmed before it can be used in the ADSL application. The reset default has the transmit channel update rate set for 276 Ksps. In order to get full transmit rates we must use the 552 ksps mode. This means setting the DBLTXS bit of the FMR register. This is done by sending a control sequence to the AFE: 0010100000000010. Programming is done once every time that the PLL locks.

Clock Recovery

The clock recovery logic provides clocking for the programmable logic. The 123.648 MHz clock is the master clock generated by the on board VCO. A PLL is used to ensure that this clock is frequency locked to the 61.824 MHz recovered receive clock from the AMCC transceiver. The majority of the logic is driven from the 61.824 MHz clock. The phase lock loop is programmed (PLL CNTRL) to enable it to generate a locked signal, defined as when the absolute phase error is <15 ns for five consecutive reference cycles. This programming is done using the PLL's 3 Wire Serial bus. The PLL returns a signal to the logic when it has successfully locked to the incoming 61.824 MHz receive clock. Note that if the SAC MUX is disconnected the PLL will lock to the local float value of the VCO and report a lock. Once the SAC MUX is connected the PLL will go to a “not locked” state and report this to the logic. Once locked to the receive signal the locked pin will indicate regaining the lock. For our purposes the PLL is considered locked after 2²⁵ consecutive commas have been received while the PLL has reported being locked (commas received on 123.648 MHz cycles which gives about a 270 ms delay). Once the PLL has locked the logic's DLLs are allowed to lock to the incoming 125 MHz, 61.824 MHz and the logic will begin to generate the AFE's 35.328 MHz clocks. Once the DLLs have all locked the remaining programmable logic circuitry is taken out of reset.

Link Manager The Link Manager controls all aspects of the fiber channel's formation and tear-down. The state machine is illustrated in FIG. 25.

On reset the state machine enters a program state. This state is designated to allow any future initialization to take place. When the initialization is complete the CO MUX begins sending BREAK control characters to the SAC MUX. This continues until the PLL has been locked.

SAC MUX detection causes the CO MUX to send COMMAs in return. The SAC MUX will then begin to send its data stream preceded by a pair of SOP characters. The state machine processes this pair and synchronizes its reception buffers appropriately. If the PLL goes out of lock or invalid characters are received the CO MUX begins sending BREAKs to signal an error condition and restarts the negotiation.

After the SOPs have been received the state machine waits for an internal signal from the transmit buffer before sending its own SOP pair. This is done to ensure that data can be sent out in the appropriate order while maintaining internal buffering counts. After the SOPs have been sent the negotiation is deemed complete.

During normal operation the state machine looks for COMMA signals, 3 decoding errors in a row and PLL unlock conditions. Any of these conditions are responded to by renegotiating the link. COMMA signals indicate that the SAC MUX wants to renegotiate. Expected errors are so rare that if more than one decoding error is detected in a row the link is assumed to be down. The PLL will unlock if there is a sudden change in the recovered data clock; this will only occur if valid data is no longer being received.

8 B10 B Encoding and Decoding

This encoder and decoder outputs conform to IBM's 8 B10 B U.S. Pat. No. 4,486,739 but are implemented differently. The encoder codes 16 bits of data into 20 bits of encoded data. This data is then MUXed back up to the full rate useable for output. Similarly the decoder takes 20 bits of encoded data and produces two 8 bit bytes and control signals for each byte. The encoder and decoder are currently implemented using intensely pipelined combinational logic although a look up table approach is available to accomplish the same result.

The encoder has been modified to accept four types of information. The typical case is simply 16 bits of data that needs to be encoded. Three signal lines are also available to allow sending COMMA, SOP, or BREAK pairs. The asserion of the signal lines takes precedence over the sending of data.

The decoder has been adapted to report the presence of three types of signal in either byte of the input data. This allows the reporting of six signals: COMMA_msb, BREAK_msb, SOP_msb, COMMA_lsb, BREAK_lsb, SOP_lsb. In addition an error signal is reported if the character being decoded is an invalid code or if the disparity is not as expected. If none of these signals are asserted the data output is clear data.

Receive Buffers

The implementation allowed each of two FPGAs to receive data concurrently from the AMCC transceiver. Since only half the data decoded is useable by each FPGA, SOP alignment was used to control a 16:8 MUX that controlled the data fed to the receive buffers. The MUX divides each 16 bits out of the decoder into data meant for channels 1-16 or channels 17-32. FPGA U1 controls the AFEs that use channels 17-32 and FPGA U2 controls the AFEs that use channels 1-16.

The receive buffers are used to convert the 8 bit wide data from the decoder to 14 bit wide data used by the AFEs. For each of the two groups of channels a 56 bit register is filled 8 bits at a time until full. This register content is then transferred to four 14 bit registers corresponding to one channel per connector, JA CH0, JB CH0, JC CH0, JD CH0 for example. Each AFE can then access this registered data as needed.

Transmit Buffers

The transmit buffers are used to convert the 14 bit AFE data to 16 bit wide data required by the encoder. FPGA U1 controls the AFEs that use channels 17-32 and FPGA U2 controls the AFEs that use channels 1-16. On each FPGA a 56 bit wide register is filled with the data from four 14 bit registers corresponding to one channel per connector. The encoder is fed this data, 8 bits from each FPGA, until the register is depleted. The next channel data for each connector is then loaded into the 56 bit register and the cycle repeats. A flag is set just before the first channel of the first connector is sent to the encoder. This flag is used by the state machine to ensure that the data is sent.

In order to send correct 8 B10 B encoded data to the AMCC transceiver, only one FPGA can communicate with it at a time. FPGA U2 was thus designated as a secondary device that transmits by breaking its data down from 8 bits wide at 61.824 MHz to 4 bits wide at 123.648 MHz and sending this to FPGA U1 via a 4 bit bus. This data was then reconstituted to 8 bits wide and combined with 8 bits of corresponding U1 data which is sent 16 bits wide to the encoder. This 4:8 and 8:4 conversion required reset states to be closely coordinated to ensure the data could be recovered and sent by the two FPGAs.

The system as described above includes the following features of technical importance.

One important new feature acts to embed framing information in the transmit data streams (up and down) to assure channel synchronization. The framing information is continuously scrutinized at the receiving end to assure that channels are not scrambled in transit. Downstream channel-data occupies 100 % of the available bandwidth.

As an alternative, traditional serial communication overhead bits could have been added at the expense of the number of channels supported; however, the embedded framing approach allows the system to maximize the number of channels at the expense of a very small decrease in the signal fidelity for one channel.

Not all channels require the framing information to keep the system synchronized. Instead, each of the system's two field programmable gate arrays (FPGA) need only one framing channel. Therefore for the system, only two of 32 channels contain the framing information.

Thus in implementation of this system, happening once each ADSL symbol period (250 us), the least significant bit (LSB) of one channel's digital sample carries embedded framing information. Each symbol period, the digital value of this bit is overridden by the current value of a known pseudo random bit stream (PRBS). The system implemented a maximal length sequence with a 15 bit period using a four bit linear feedback shift register (LFSR).

Two independent sequences are used (one for each FPGA). The same sequence is used for both upstream and downstream directions of a particular channel.

The sequences are defined by the following equations: X0 =X3 XNOR X4, and X0 =X1 XNOR X4 . Both sequences are seeded with all zeros.

The receiving end discriminates against invalid sequences by monitoring the a moving window of the four most recent bits of the bit stream. The discriminator tolerates no more than one bit error in the window. This tolerance level is high enough to allow an isolated transport related bit error incident which would occur only rarely based on the IEEE 802.3 Gigabit Ethernet standard's required bit error ratio of 10 ˆ -12. The probability of a second error seen at the exact right bit time (one of four in the window) purely by chance is extremely low and so is ignored. Instead the system treats the case of two or more errors in the window as a framing error and therefore take corrective measures. The system indicates no measurable channel degradation.

The system uses fixed gains (unity) for both downstream and upstream paths to simplify the design and ensure faithful reproduction of all ADSL signals so as to minimize impact on ADSL communications. An analysis of the system shows that the signal to noise ratio (SNR) is adequate to support nearly full rate ADSL signals across the entire dynamic range of those ADSL signals. Here “nearly” means typically 95 % of full rate.

The system uses standard components in novel ways to perform the ADSL copper to fiber multiplexing. These components include Gigabit Ethernet (IEEE 802.3 compliant) laser transceiver modules and serializer-deserializers (SERDES), as well as ADSL coder-decoders (CODEC) and line drivers/receivers.

Alternative full Gigabit Ethernet IEEE 802.3 compliant solutions require additional components including media access controllers (MAC). Similarly, full ADSL solutions also require additional components including data-pumps. The present system does not require those additional components.

The system uses Loop timing as described in detail hereinbefore to facilitate the use of standard ADSL analog front end (AFE) chips that typically use a single clock for both up- and down-stream paths.

The copper to fiber to copper topology extends the ADSL distribution range but does not introduce additional copper and so degrades the signals very little. Neither does it demodulate/remodulate the ADSL signals anywhere in the chain as some repeaters may. By avoiding this additional processing the system remains fundamentally simpler.

Since various modifications can be made in my invention as herein above described, and many apparently widely different embodiments of same made within the spirit and scope of the claims without departing from such spirit and scope, it is intended that all matter contained in the accompanying specification shall be interpreted as illustrative only and not in a limiting sense.

1. Apparatus for distributing ADSL signals to customer premises from a central office, comprising:
a central office;
the central office having a POTS switching system;
the central office having ADSL connection terminals that connect to a data network;
a plurality of customer locations at least some of which have at least one voice frequency POTS terminal and at least one ADSL terminal;
a field cabinet associated with the plurality of customers;
a plurality of individual metallic telephone lines each extending from a respective one of the customers to the field cabinet;
a trunk cable containing a large number of metallic telephone lines and extending from the field cabinet to the central office;
the field cabinet including a plurality of connections for connecting the individual telephone lines to the trunk cable for connection of signals between the customer locations and the central office;
the individual metallic telephone lines each being arranged to transmit both voice frequency POTS signals and ADSL signals between the respective customer location and the field cabinet;
a bi-directional link separate from the trunk cable for the transmission of ADSL signals between the field cabinet and the central office for connection to the data network; and
a splitter and interface module at the field cabinet having:
a plurality of signal splitting coupler units each associated with a respective one of the individual telephone lines and each arranged to separate the ADSL signals and the voice frequency POTS signals from the respective telephone line;
a plurality of connectors each arranged to connect the separated voice frequency POTS signals between the respective individual telephone line and the trunk cable; and
a plurality of interface units each associated with a respective one of the coupler units for receiving the separated ADSL signals from the coupler unit and for communicating the bi-directional ADSL signals on the bi-directional link between the central office and the respective individual telephone line.

2. The apparatus according to claim 1 wherein the interface units at the field cabinet and the central office have a common receive and transmit clock and are synchronized in both directions providing precise loop timing where one end supplies the master clock for the channel and the clock is recovered at the other end, used to receive the data, cleaned up and used to send the data back.

3. The apparatus according to claim 2 wherein the interface units at the field cabinets and the central office are arranged such that the framing information is continuously scrutinized at the receiving end to assure that channels are not scrambled in transit.

4. The apparatus according to claim 3 wherein not all channels require the framing information to keep the system synchronized and wherein instead, each of the system's two field programmable gate arrays (FPGA) need only one framing channel.

5. The apparatus according to claim 4 wherein only two of 32 channels contain the framing information.

6. The apparatus according to claim 3 wherein once each ADSL symbol period (250 us), the least significant bit (LSB) of one channel's digital sample carries embedded framing information and in each symbol period, the digital value of this bit is overridden by the current value of a known pseudo random bit stream (PRBS).

7. The apparatus according to claim 6 wherein the interface units are arranged to provide a maximal length sequence with a 15 bit period using a four bit linear feedback shift register (LFSR).

8. The apparatus according to claim 3 wherein two independent sequences are used (one for each FPGA) and the same sequence is used for both upstream and downstream directions of a particular channel, where the sequences are defined by the following equations: X0 =X3 XNOR X4, and X0 X1 XNOR X4 and both sequences are seeded with all zeros.

9. The apparatus according to claim 3 wherein the receiving end discriminates against invalid sequences by monitoring the a moving window of the four most recent bits of the bit stream and the discriminator tolerates no more than one bit error in the window and treats the case of two or more errors in the window as a framing error and therefore take corrective measures.

10. The apparatus according to claim 1 wherein the interface units are arranged to use fixed gains (unity) for both downstream and upstream paths.

11. The apparatus according to claim 1 wherein the interface units include Gigabit Ethernet (IEEE 802.3 compliant) laser transceiver modules, serializer-deserializers (SERDES), as well as ADSL coder-decoders (CODEC) and line drivers/receivers.

12. The apparatus according to claim 1 wherein there is provided a plurality of interface units at the telephone central office each of which the bi-directional link associated with a respective individual telephone line and each of which provides an interface between the respective ADSL signals on the bi-directional link and the ADSL terminal of the central office.

13. The apparatus according to claim 1 wherein each interface unit includes an analog front end unit for converting between analog signals transmitted to and received from the individual telephone line and digital signals for transmission on and receipt from the bi-directional link,

14. The apparatus according to claim 13 wherein the analog front end generates parallel data and wherein there is provided interface components for converting between the parallel data and a serial digital signal for communication on the bi-directional link.

15. The apparatus according to claim 14 wherein the analog front end comprises an ADSL codec and filter.

16. The apparatus according to claim 14 wherein the interface components include a serializer/de-serializer unit arranged to receive the parallel digitized ADSL signals and serialize them onto a single bit stream and to receive a serial bit stream and generates therefrom parallel data.

17. The apparatus according to claim 11 wherein serializer/de-serializer also is arranged such that if frame synchronization is lost, then the communication link is recreated by a protocol, whereby if a transceiver loses frame synchronization, it simply ceases transmission to the other transceiver, then the other transceiver will receive idle characters, signaling it to restart transmission and such that once the original transceiver detects frame synchronization, it will begin transmitting data again, and the link will be re-established.

18. The apparatus according to claim 1 wherein there is provided a power supply unit arranged to receive power from each subscriber premises to power its own channel over the tip and ring phone line.

19. The apparatus according to claim 1 wherein there is provided a power supply unit arranged to receive power from the central office to power the parts of the interface unit common to all channels.

20. The apparatus according to claim 19 wherein the power supply unit is arranged to receive power from the central office by two tip and ring lines.
